(19) United States
(12) Patent Application Publication
(10) Pub. No.: US 2015/0019402 A1
(43) Pub. Date: Jan. 15, 2015

(54) SYSTEM AND METHOD FOR PAYMENT PROCESSING, MERCHANT ACCOUNT APPLICATION, AND UNDERWRITING

(71) Applicant: PaySimple Inc., Denver, CO (US)

(72) Inventors: Evan Berlin, Denver, CO (US); Wesley T. Cropp, Denver, CO (US); Lisa A. Hephner, Denver, CO (US); David Sharp, Denver, CO (US)

(21) Appl. No.: 13/939,945

(22) Filed: Jul. 11, 2013

(51) Int. Cl. G06Q 40/02; G06Q 20/24

(52) U.S. Cl. CPC G06Q 40/025; G06Q 20/24
USPC 705/38

(57) ABSTRACT

A system and method for payment processing system account application, payment processing merchant account application, and payment processing merchant account underwriting is disclosed. A system presents a user interface which collects user data for a single application for a several services in a broad class of services. In an embodiment, the single application is appropriate for applying for automated clearing house (ACH) accounts from multiple ACH processors, and credit card accounts from multiple CC processors. Questions are not duplicated on the form, and only one electronic signature is required for all of the relevant application documents. Embodiments include the system performing prescreening of users to detect non-qualified applicants before submission of the application to processors. Embodiments further include selection of processors based on collected information; selection of alternate processors should a user screen out of the initially assigned choice; and automated underwriting and customer boarding for approved applications.

### FIELD OF THE INVENTION

The claimed invention is in the field of systems and methods for provisioning entities (typically merchants) to accept online payments, including provision of invoicing and payment acceptance solutions, and streamlined application(s) for payment processing merchant accounts including credit card processing and ACH processing accounts.

### BACKGROUND

Currently, there are many systems for allowing a user or consumer online to purchase a service or product through a user interface (UI), or pay an invoice through the UI. These systems vary greatly in complexity. Relatively small businesses typically do not have the ability or resources to develop and deploy such systems and so they purchase them from suppliers. On the other hand, even very large businesses may choose to purchase such systems rather than build them. Existing merchant systems for online invoicing and payment acceptance include various components. These include: online forms used for applying for merchant processing accounts, or other services; dynamic online forms that use initial data to generate additional questions on the form; a single form used to submit data to multiple third parties; and integration of online form data into multiple external systems via an application programming interface (API) or other input method.

An example of using a single application to submit data to multiple sources is the Mercury Magazine application which uses a single process to present free industry magazines to potential subscribers and then present application forms for those to which people want to subscribe. The Mercury system first asks for basic contact information (name, email, country), and basic information about company size, industry, and, job function. Based on those entries, it filters the list of potential magazines offered. Applicants then select the magazines to which they would like to subscribe. Based on those selections, applicants are presented with a set of screening questions provided by each magazine. There is duplication in these questions, because they are presented as unique sets for each magazine, they are not aggregated into a single question set in order to remove duplication. Applicants answer all the questions. Based on responses, magazine publisher-provided filters are used to determine if the applicant qualifies to receive each magazine. The applicant is shown a screen displaying the magazines for which they have qualified, and is asked to submit a single address form. Address information is sent to each magazine publisher in order to fulfill the subscription. A subscription for the magazine is entered and executed by the publisher for the applicant.

Another example would be a system, like those developed by Lending Tree, Bank Rate, and other personal loan comparison sites, that uses a single data entry form to collect data and to perform preliminary underwriting screens of loan applicants. The system then forwards collected data to third party loan providers so that they can make loan offers to applicants that meet their qualification requirements.

Other examples of prior systems include enrollment processes that facilitate setting up merchants with credit card (CC) or automated clearing house (ACH) accounts. Typically these systems require the merchant to provide extensive business information, and return a substantial amount of documentation via mail or fax.

Simplified online applications and approval systems for shared payment processing accounts currently exist. (A shared payment processing account is one in which the service provider actually holds the merchant account and processes transactions on behalf of all of its merchants using the same merchant account, e.g. the PayPal™ model.) While this process often requires minimal information from merchants, and typically results in near real-time approval decisions, shared merchant accounts are not equivalent to dedicated merchant accounts—they are completely controlled by the service provider which can set its own rules, hold funds at will, suspend processing without notice, and increase fees without notice. Additionally, fraudulent activity by one merchant under the service provider's umbrella can cause processing rights for all of its merchants to be terminated. However, many merchants opt for the shared payment processing account solution because they find the process of applying for dedicated merchant accounts too complicated and cumbersome.

Earlier methods attempted to simplify the application process for dedicated credit card and ACH payment processing merchant accounts. One such method used an online system via which extensive business and authorized signer information was collected and screened as part of an application for dedicated credit card and/or ACH payment processing merchant accounts. In this implementation, provisionally approved applicants were presented with multiple service agreements in PDF format, each of which needed to be separately reviewed and digitally signed. While this process did greatly improve the time it took to underwrite and approve dedicated merchant accounts, it asked for a considerable amount of information and could take quite a while for a merchant to complete, resulting in a higher than optimal rate of abandonment.

There is a need for a more streamlined process that minimizes the amount of time and data input required of the user. There is also a need for a system that can perform a substantial amount of pre-qualification underwriting tasks prior to transmitting an application to a merchant account provider, which will result in a faster progression from application submission to approval and account activation.

### BRIEF DESCRIPTION OF THE DRAWINGS

FIGS. 1-20 are user interface screens for an application user interface according to an embodiment.

FIGS. 21-30 are flow diagrams illustrating an application process according to an embodiment.

FIG. 31 is a block diagram of a system according to an embodiment.

### DETAILED DESCRIPTION

A system and method for provisioning businesses for online invoicing and payment acceptance, including underwriting Credit Card (CC) merchant processing accounts, automated clearing house (ACH) merchant processing accounts, and Check 21 merchant accounts are disclosed. Embodiments of the system provision small to medium-sized businesses in near real-time for an on-demand, software-as-a-service (SAAS) e-invoicing and payments acceptance solution, while providing an easy, pleasant customer experience. For purposes of illustration herein, the application and provisioning system and method is referred to as Simple Sign-Up® (or SSU); the online invoicing and payment acceptance system and method is referred to as a PaySimple® payment system and method, or PaySimple platform; and a customer configuration and management system and method is referred to as CAMP®. An embodiment includes an automated online application process by which a merchant can complete a single online form to sign-up for a PaySimple account, apply for a credit card merchant account, apply for an ACH merchant account, and/or apply for a Check 21 merchant account.

Embodiments of a streamlined process combine key components of underwriting and authorization in a single interface that sends appropriate data to each party so that it can be saved and processed in the appropriate system.

Embodiments guide the user flow seamlessly from the point of his or her purchase decision to software activation. Users are also referred to herein as clients, applicants, or customers. Embodiments collect relevant payment information and business information from the user, perform a series of web service database queries based upon the user's entries, complete an evaluation routine and automatically trigger the necessary provisioning routines with various payments partners.

Embodiments aggregate filters so users are not required to answer the same questions twice. External web service calls are used to generate additional information about an applicant. External web services are used to evaluate the validity of the information provided. External web services are used to validate the identity of the applicant. An electronic signature for the single application is obtained. A single results file is used to submit applicant information to third parties. In the application process according to embodiments, the system performs round-trip communication between the data provider and third parties. In an embodiment, an applicant user submits a Simple Sign-Up® (SSU) application which is presented in an SSU user interface (UI.) Transparent to the user, the system submits the SSU application to one or more processors. Processors include automated clearing house (ACH) processors, Check 21 processors, and credit card (CC) processors. The system receives processor decisions, and credentials if approved.

Embodiments combine multiple merchant account applications (ACH, CC, etc.) into a single application form. In addition, embodiments combine signing up for a payment processing solution with applying for (and obtaining) dedicated merchant processing accounts. Further embodiments provide white label versions of a SSU application for integrated partners offering a custom branded version of the system software.

Embodiments dynamically route merchants to merchant account providers based on risk and other profile data obtained in initial application stages. Embodiments dynamically present questions from a common pool to collect data required by the processor to which a merchant has been assigned (based on initial responses), and applies processor-specified filters to that data. Third party web-services are contacted for identity and risk evaluation, as well as to obtain additional information about the applicant.

The system and method disclosed herein includes an automated application and boarding process (submit application to processor, obtain process result and credentials, use credentials to provision merchant to use the system software.) Embodiments use a single e-signature to agree to a multi-document set of terms and conditions, pricing, and other contracts using checkboxes and a single submit button that generates a terms page (and/or terms XML data set) that is transmitted to relevant third parties.

According to embodiments, resellers can white-label a merchant account application in conjunction with a white-label version of the system software itself. Resellers offering a white-label version of the system software as described herein can customize a white-label version of SSU that they use to underwrite their own payment processing merchant account applications. (e.g., a bank provides its own ACH processing account (not one from a system ACH provider) which is integrated into its white-label instance of the system software.) The white-label SSU application is used to obtain the data and electronic signatures the bank needs to underwrite ACH processing accounts, and to implement the automated application and boarding of customers on the white-label system platform so that merchants can use the system, and the bank can manage those merchants in a customer activation management platform (“CAMP”.)

In an embodiment, a SSU platform cooperates with a merchant account provider that also performs its own underwriting in addition to the underwriting information provided via the SSU process. According to this embodiment, minimum information needed from the SSU process to successfully begin the underwriting process for an applicant is determined. The applicant is asked for that information only, considerably shortening the form and the application process. The merchant account provider undertakes additional underwriting themselves as part of the merchant approval process. Applicants have an opportunity to view/print each contract/terms document online during the application process and use checkboxes and a submit button to effect an electronic signature, instead of having to individually sign PDF documents. Embodiments of the SSU process enable individual payment processing merchant account providers to be attached to a dedicated application instance. In this case, screens custom-built for the attached provider are built and web service database queries required by the assigned processor are used as part of the process. Screening values defined by the processor are used to route users to the automated, manual, or denied path.

Embodiments of the SSU process combine underwriting requirements from multiple payment processing merchant account providers. According to this embodiment, a process flow uses a combination of custom-built screens native to the SSU application process, a pool of processor defined questions, a pool of web-service database queries, and a dynamic routing application to route merchant applicants to one of a pool of available credit card and/or ACH merchant account providers based on initial screening information.

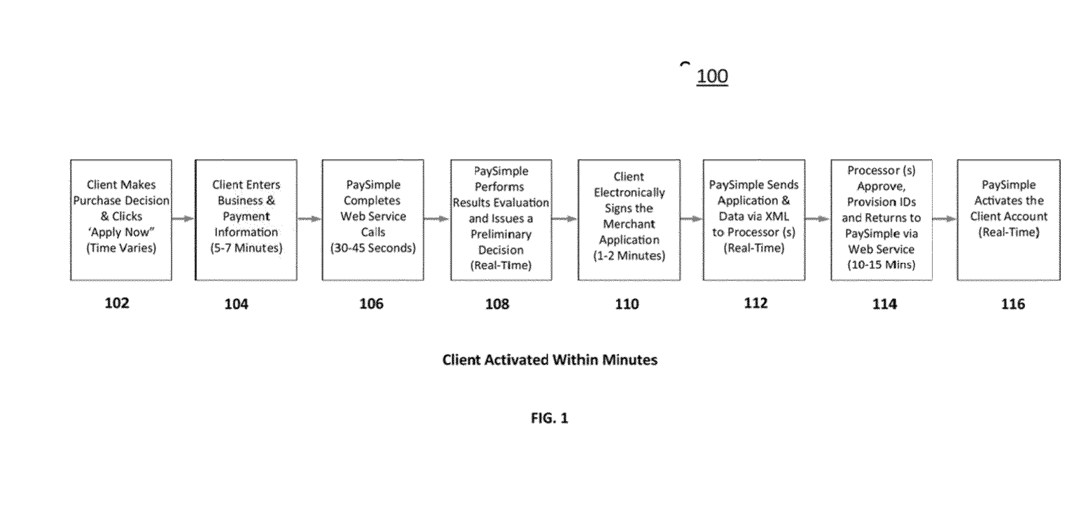

FIG. 1 is a block diagram of a SSU flow 100 according to an embodiment. A client makes a decision to purchase and clicks an “Apply Now” button as shown at 102. As described herein the client is applying to purchase a software-as-a-service (SAAS) invoicing and payments product also referred to as a PaySimple® solution, but embodiments are not so limited. A PaySimple SAAS product is used as an example of something that a user can apply for and purchase using the embodiments described herein.

At 104 the client enters business and payment information. This is estimated to take only 5-7 minutes. At 108, a results evaluation is performed and a preliminary decision is immediately issued. At 110, the client electronically signs the merchant application. The merchant application and data is sent to processor(s) immediately (in real-time). The receiving processors approve the specific applications received by them (e.g., credit card application and/or ACH application), provision identification information (“ID” or credentials), and return the information to the system via a web service. At 116 the system activates the client account in real-time and the client is able to accept electronic payments.

Various embodiments of the SSU flow include: an SSU application system and method for users to apply for one or both credit card (CC) services and ACH services from a single provider; an SSU application system and method for user's to apply for CC services from a single provider; an SSU application system and method for users to apply for ACH services from a single provider; an SSU application system and method for users to apply for Check 21 services from a single provider; an SSU application system and method for users to apply for one or both of CC services from one single provider and ACH services from one different single provider; an SSU application system and method for users to apply for one or both of CC services from one single provider and Check 21 services from one different single provider; an SSU application system and method for users to apply for a reseller whitelabel version of the PaySimple Solution via a whitelabel version of the SSU application system; a SSU application system and method for users to apply for reseller provided credit card (CC) services and/or ACH services via a whitelabel version of the SSU application system for use in conjunction with a whitelabel version of the PaySimple Solution; an SSU application system and method for users to apply for CC services from multiple CC providers; an SSU application system and method for users to apply for ACH services from multiple ACH providers; an SSU application system and method for users to apply for Check 21 services from multiple Check 21 providers; and an SSU application system and method for users to apply for one or more of CC, ACH, and Check 21 services from multiple CC, ACH, and Check 21 providers.

Various aspects of a UI for the SSU application will be described below with reference to the figures. Also, the front end (UI) and backend aspects of a an SSU application system and method for users to apply for one or more of CC and ACH services from multiple CC and ACH processors will be described in more detail with reference to the figures.

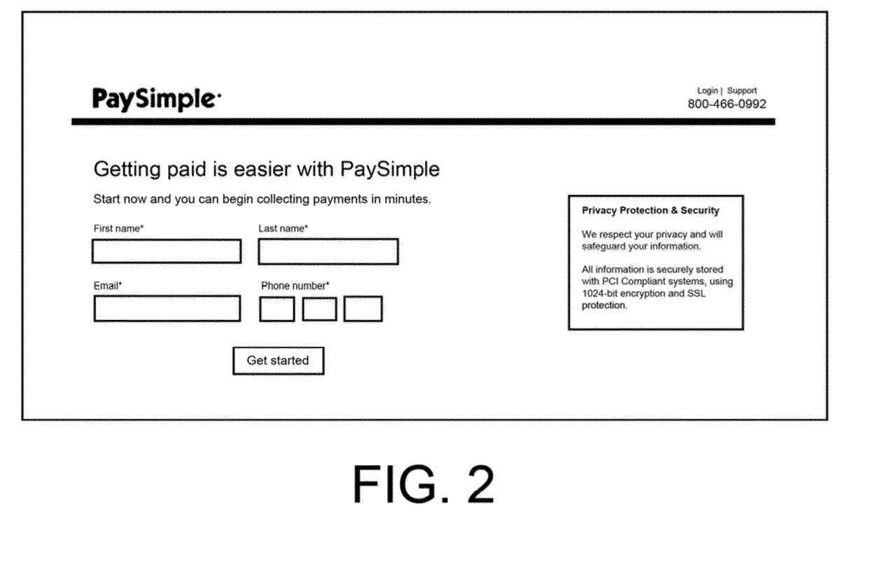

FIG. 2-FIG. 23 are illustrations of UI screens for a SSU application. The screens are shown with the PaySimple brand as an example only. Whitelabel versions are branded for reseller partners. With reference to FIG. 2, a merchant customer decides to open a PaySimple account and clicks an online button to start the process. The first page of the form asks for Name, Email and Phone Number. This information is transmitted to a customer relationship management (CRM) partner (using SalesForce™ as an example) where a “Lead” is created.

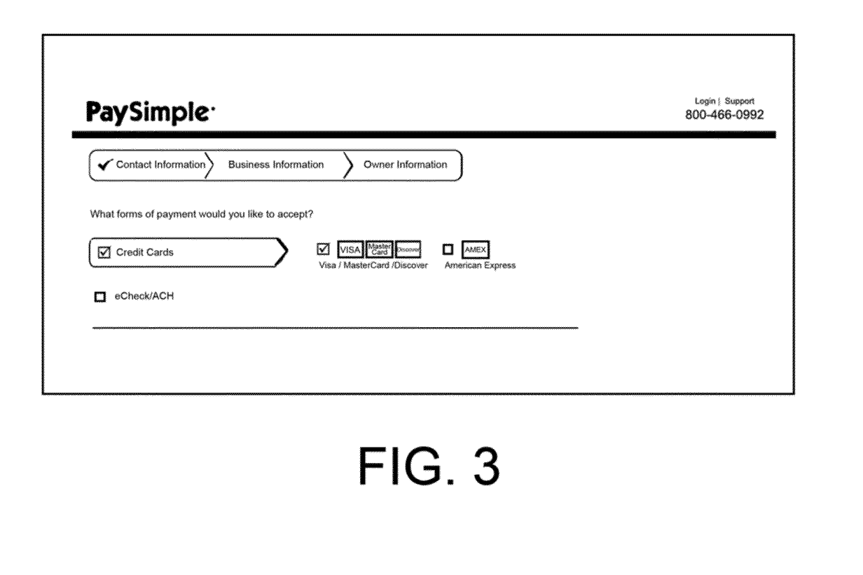

With reference to FIG. 3, a second page asks for type of payment processing accounts for which the merchant wants to apply. It also asks for business information, address, tax ID, and information about the transaction size and volume the merchant will process. Additionally, it asks for the bank account that will be billed for services and attached to the merchant accounts. Type of merchant accounts applied for is used to create the remainder of the form.

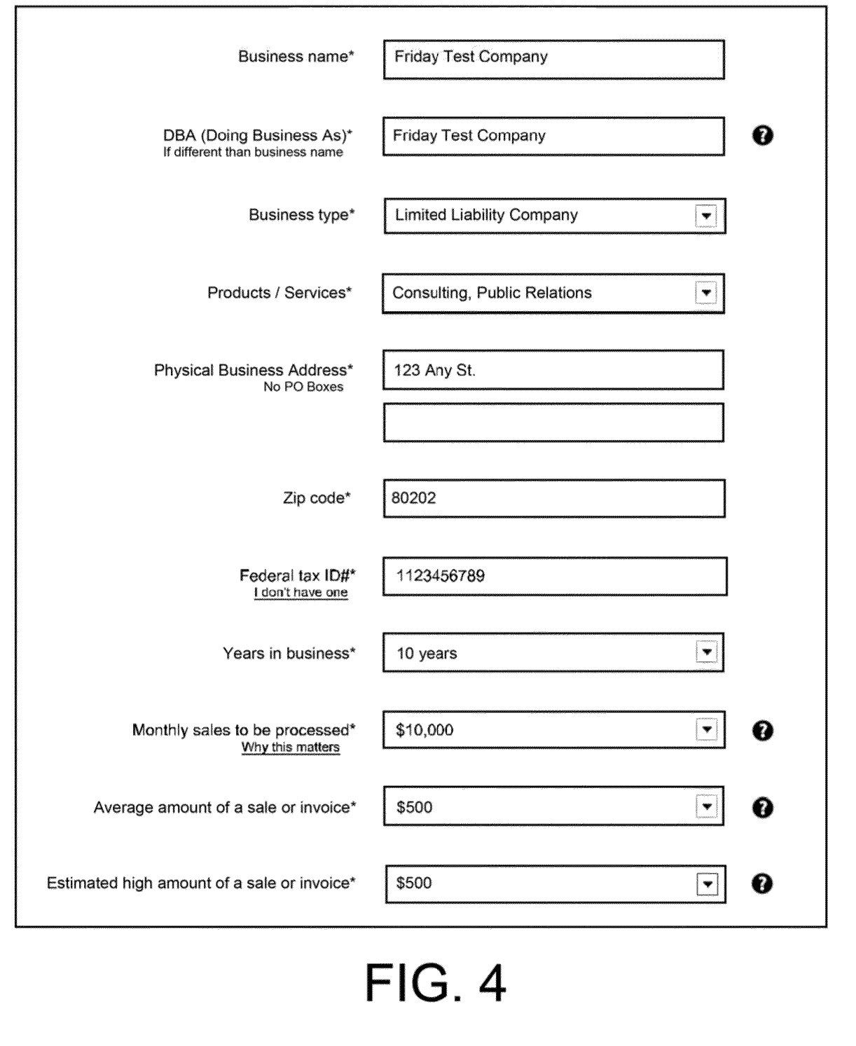

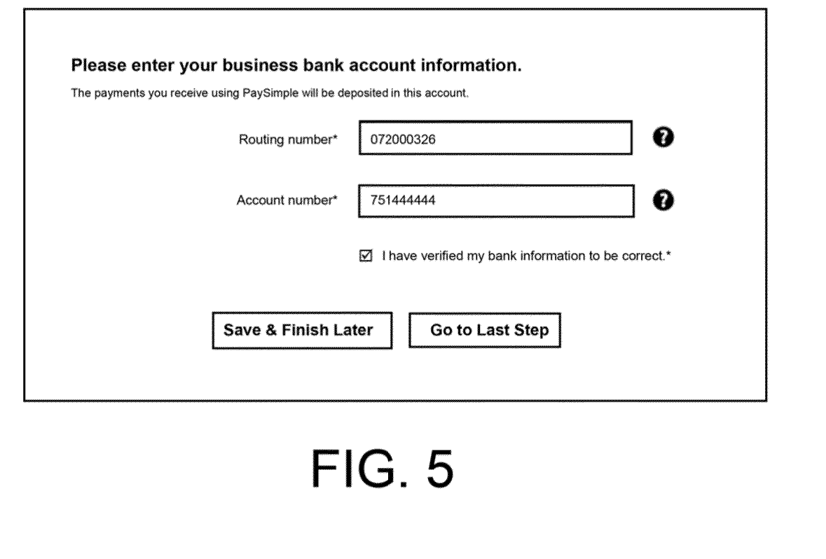

With reference to FIG. 4, the customer provides business information, address, tax ID, and information about the transactions they plan to process. Business information is used to populate PaySimple account fields in a CRM and in CAMP. Information here is used to auto-screen out merchants who cannot be approved Information here is also sent to merchant account providers for use in underwriting. With reference to FIG. 5, the customer's bank account information is obtained. This account is used for billing, and is also the account linked to CC and ACH merchant accounts.

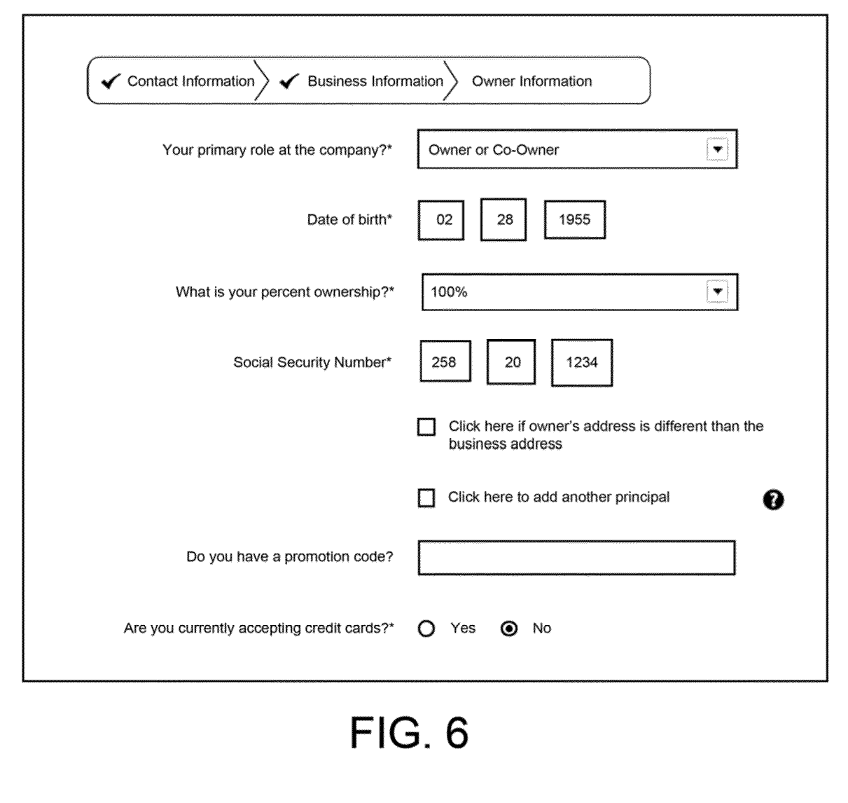

Referring to FIG. 6, the next page asks for the authorized signer(s) to be designated and asks for personal information (SS#, position in the business, years in that position), and asks the authorized signer to view and agree to all terms, conditions, and fees as well as agreeing to be billed for system transaction activity and fees by PaySimple via a monthly ACH debit. The authorized signer is the person authorized to open the merchant account and to authorize automated billing. This person may be personally liable for all transaction activity and fees.

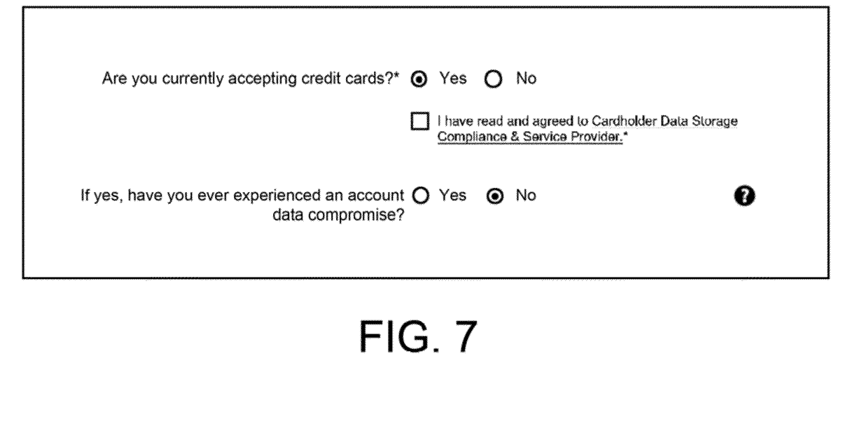

The screen provides an option to add an additional principal who will be a joint signer. This information is also sent to merchant account providers for use in underwriting. Promotional codes are used to provide discounts for monthly service fees, or special introductory discounts on processing rates. Including the code here enables the client record to be configured to use these discounts. If the merchant currently accepts credit cards (refer to FIG. 7), they are asked additional questions about payment card industry (PCI) compliance and any past security breaches.

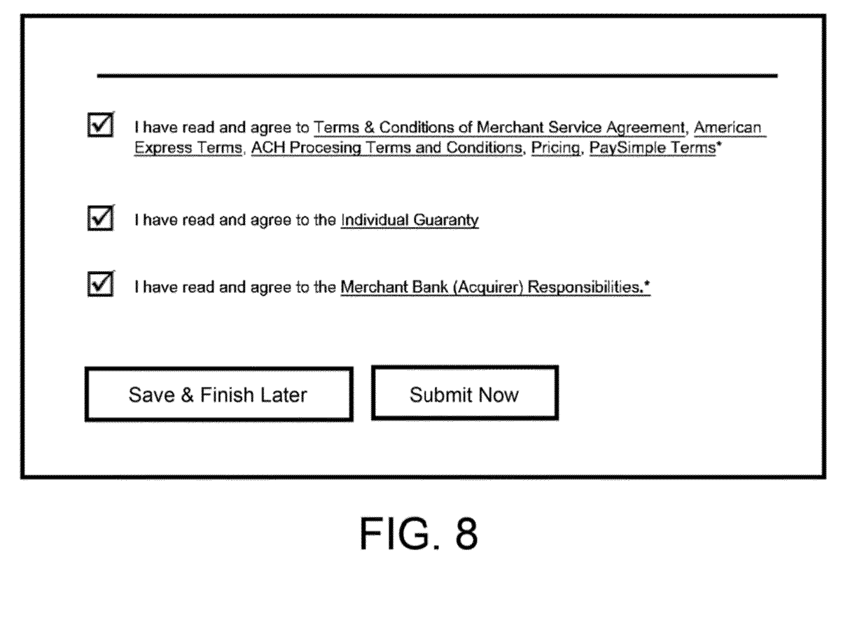

With reference to FIG. 8, the bottom portion of the screen provides the merchant access to all contracts, terms, pricing, and conditions. By clicking the submit button the merchant is agreeing to all of the checkbox items.

The information collected on this page is used to create a Signature page that acts as an e-signature on all agreements (The Submit button functions as an e-signature.) The merchant clicks the submit button, to e-sign and submit.

The merchant sees a processing screen while all the form information provided gets sent to a securely hosted PaySimple database. The CRM record that was created is converted to an “account” and associated “contact record”, and non-secure information from the form submission is seated in the record. A screen is performed on initial fail parameters (such as a foreign IP address or an authorized signer under 18 years of age). Merchants who fail out at this point see a failure screen and no further action is taken.

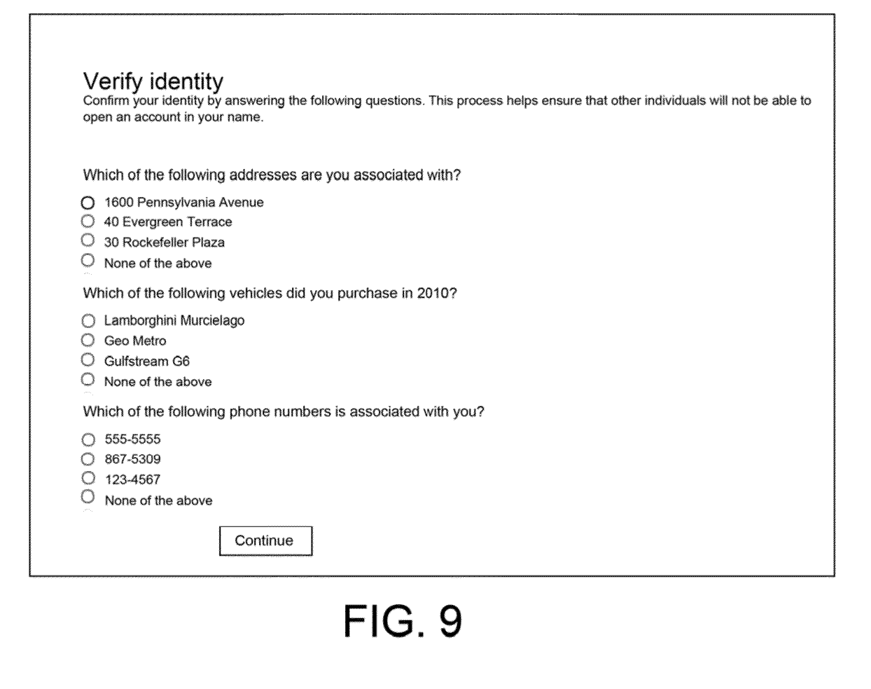

With reference to FIG. 9 the merchant is asked to complete three questions to verify identity. In an embodiment, API calls to a third party service are used for this feature.

If two out of three questions are correctly answered, the process moves to the next step. If zero or one out of three questions are correctly answered, the user is prompted to answer a second set of three questions. If two out of three questions of the second set are correctly answered, the process moves to the next step. If zero or one out of three questions of the second set are correctly answered, the application is moved out of the automated flow and into manual management. No further automated steps are taken. The merchant is told their application is submitted, but actual application and boarding will be manually handled.

Additional calls to third party service providers are made for further fraud identification, including: IP address velocity; email address velocity; risk score; credit score, and bank account status. Scores for each of these metrics are recorded and stored in the secure PaySimple database. Depending on screening settings (pre-established with the credit card and ACH providers), customers are conditionally approved and move to the next automated step, drop-out to manual servicing, or fail outright. Failures generate an online message which ends the process.

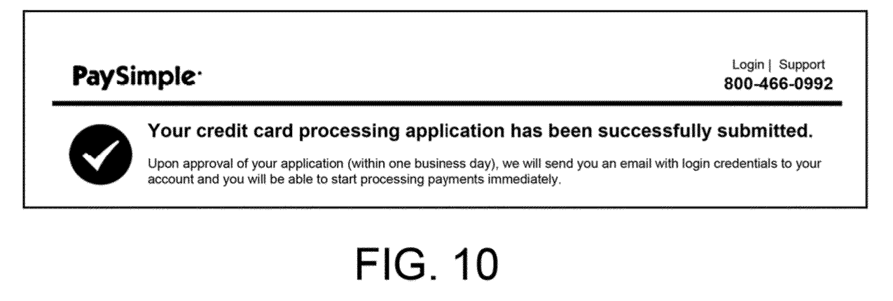

If the previous screens are passed, conditional approval is given to submit the credit card merchant account application, and the customer sees the screen shown in FIG. 10.

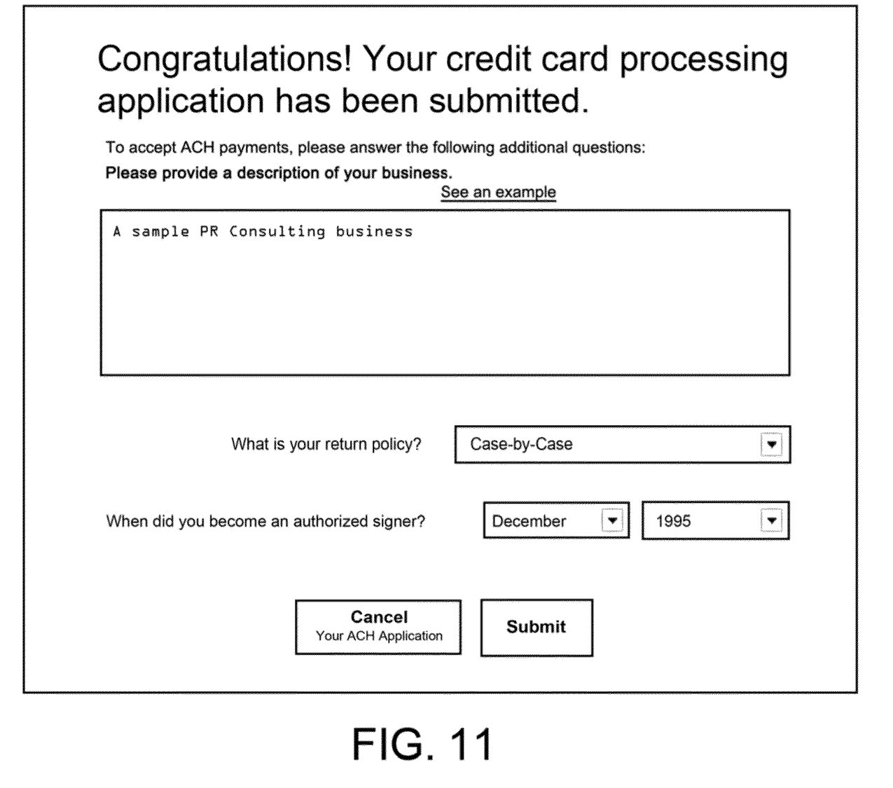

A CAMP Record for the customer is created from the form data, in a “pending” status. With reference to FIG. 11, if an ACH merchant account is also requested the merchant sees an additional screen asking for a description of the business, the return policy, and length of time the signer has been with the company. No applications are rejected outright based on this data.

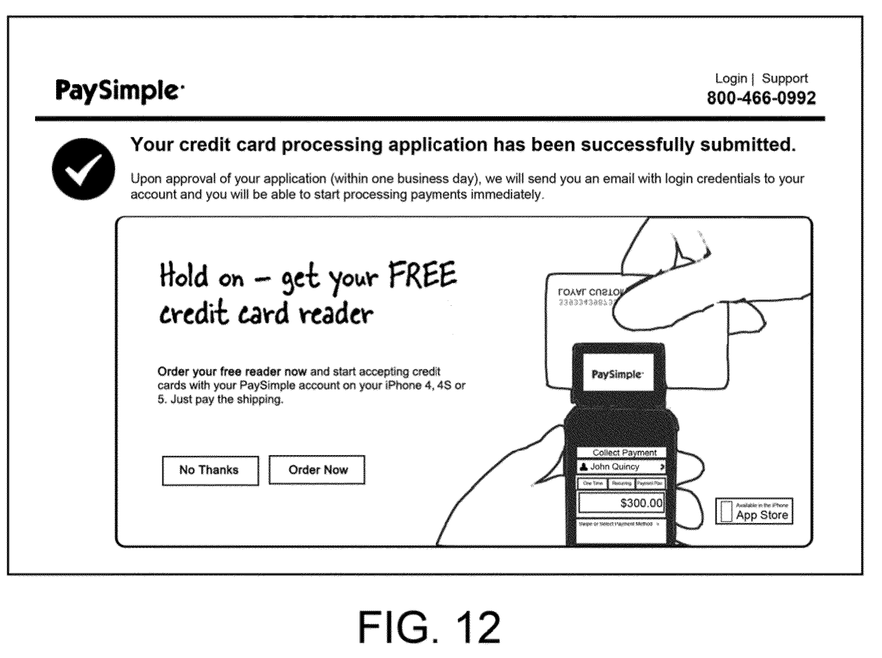

With reference to FIG. 12, the customer sees a success screen confirming that the application(s) have been submitted. If a CC merchant account was requested, the opportunity to purchase a mobile swipe device is presented.

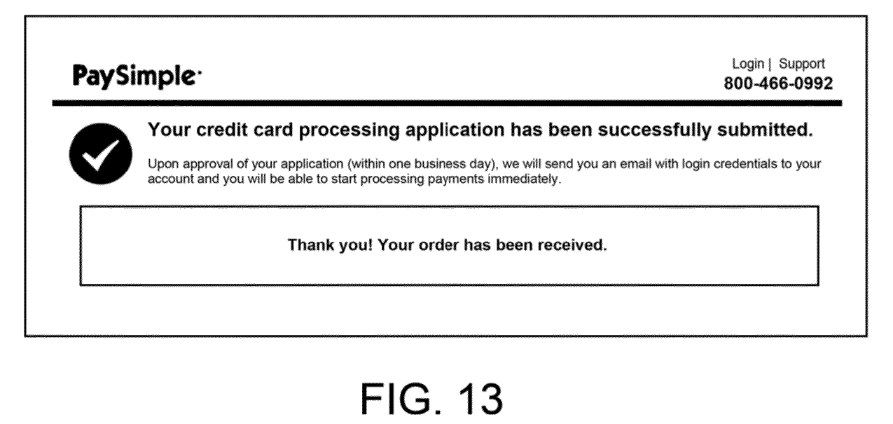

With reference to FIG. 13, a confirmation page informs the merchant that they will receive system credentials as soon as their applications have been approved.

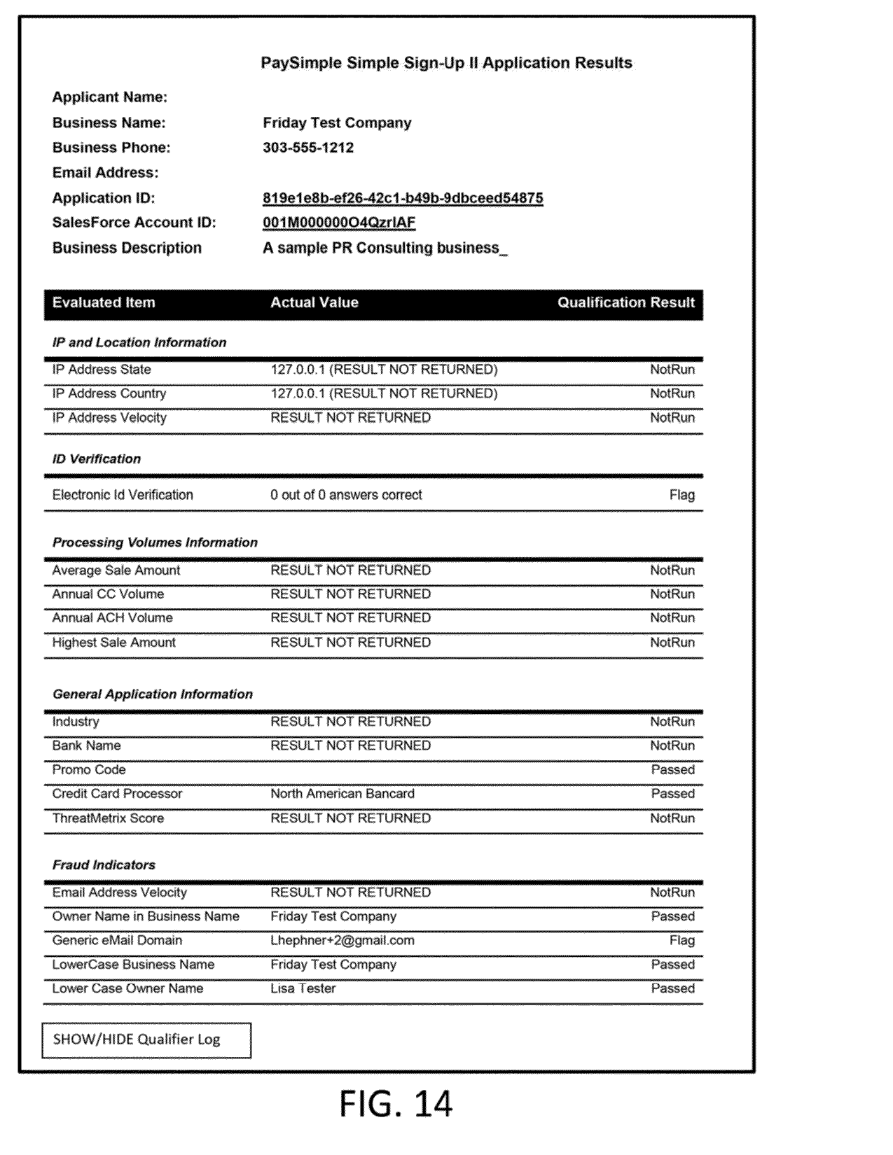

An automated underwriting, approval, and boarding process begins next. Form information is used to create a signature page attached to the CAMP record. A SSU application results page is available from the CRM record (but stored in the secure PaySimple database). With reference to FIG. 14, this page indicates the results from all the fraud module checks.

Form information and SSU application results are electronically submitted to the credit card processor via an API integration. Form information, signature page, and SSU application results are electronically submitted to the ACH processor via an API integration.

The CC processor transmits application results via secure file transfer protocol (SFTP). If the application is approved, the CAMP account is switched from “pending” to “active,” and the customer is sent login credentials. The CRM record is update to indicate “boarded.” If additional information is required, a PaySimple account specialist takes over the process and manually completes it. The CRM record is updated to indicate manual intervention is needed. If the application is denied, and only a CC merchant account was requested, the CRM account is updated to indicate denied. A member of the sales team communicates with the merchant to try to establish an ACH only or invoicing only account. If the application is denied and an ACH merchant account was applied for, the CRM account is updated to indicate that CC processing is denied, and the account remains pending until the ACH application response is received. In other embodiments, the order of these approvals/denials and reaction to the approvals/denials is varied.

The ACH processor transmits the application results via API or email. If the ACH application is approved via API, the system turns on ACH processing and configures ACH processing in CAMP. The customer then receives email notification. (In some cases this may be submitted via email, and an account manager must manually activate ACH processing.) If additional information is required, a PaySimple account specialist takes over the process and manually completes it. The CRM record is updated to indicate manual intervention is needed. If the application is denied, and only an ACH merchant account was requested, the CRM account is updated to indicate the application was denied. A member of the sales team communicates with the merchant to try to establish an invoicing only account. If the CC merchant account is approved, the CRM account is updated to indicate that ACH processing is denied, and the account remains open with CC processing only.

In embodiments of the SSU process, a customer can be auto-configured and accepting payments in a matter of hours without any manual intervention by system employees.

Various embodiments include an optional ability to save an application in progress and retrieve it at a later date. This component can be used with any of the SSU implementations described herein. However, it is not a necessary component of the SSU process.

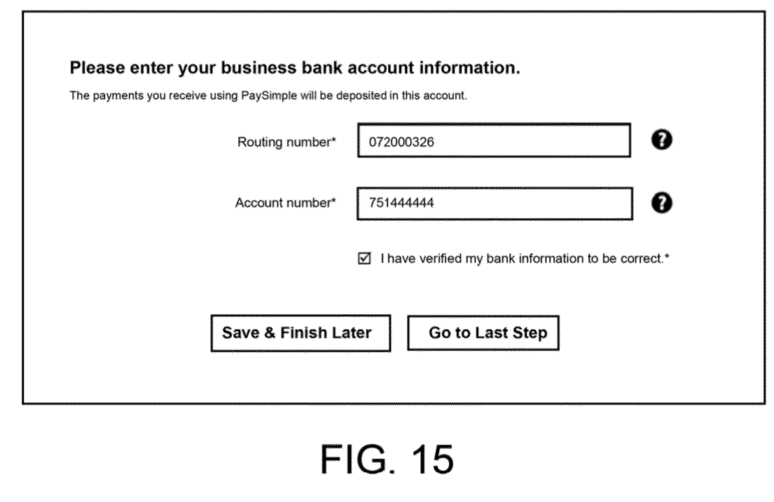

With reference to FIG. 15, the save-and-retrieve process is as follows: At any point after the first application page (where name, email, and phone is provided), merchants have the option to save the application so that they can return and finish it later. To do this, merchants click the “Save & Finish Later” button.

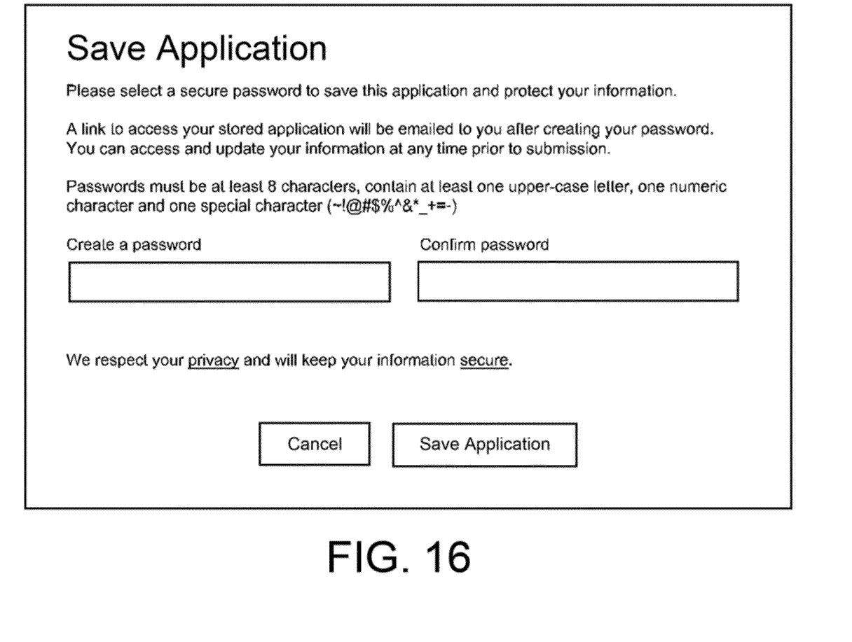

With reference to FIG. 16, a save application screen opens, in which merchants are asked to create a password that will be used to retrieve the application.

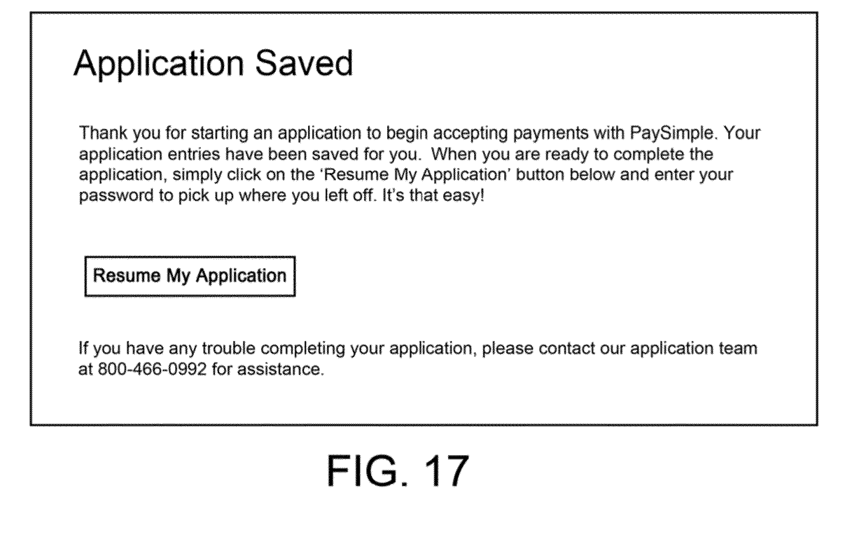

An application saved screen (FIG. 17) with a resume button is displayed. Clicking this button re-starts the application process.

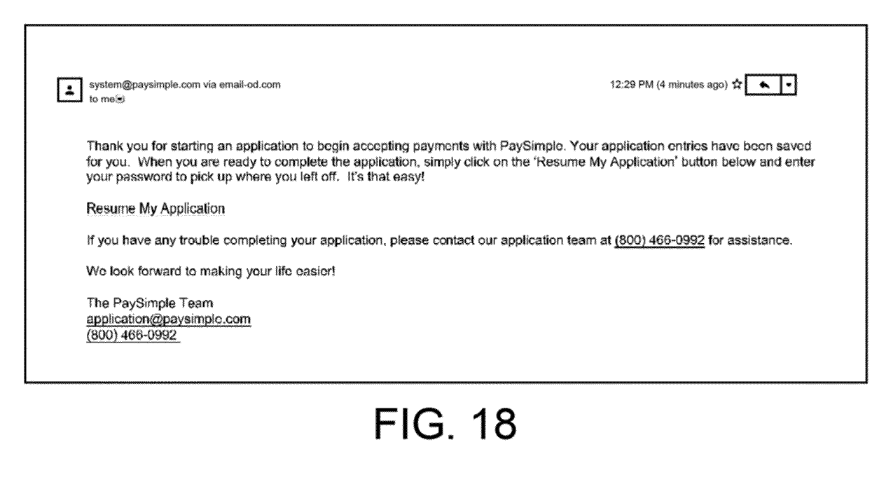

With reference to FIG. 18, an email with the resume link is also sent to the email address provided on the first page of the application.

The lead record created in the CRM (e.g., SalesForce™) after the first page of the application was submitted is updated with the resume link so that it can be provided to the merchant should they call in to sales with questions about the application or because they did not receive the resume email.

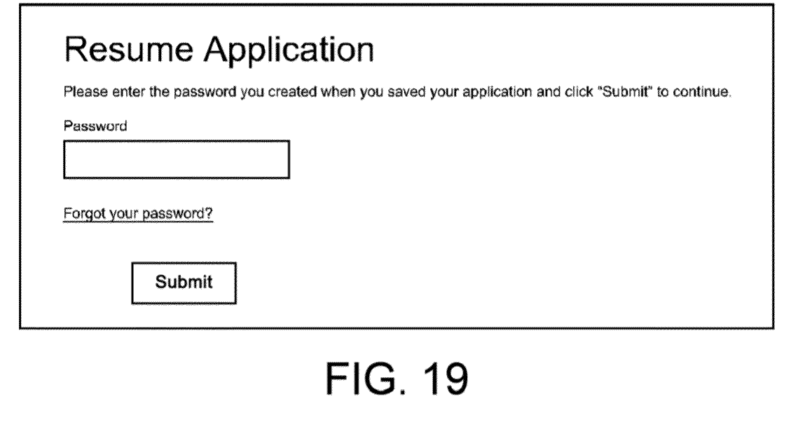

With reference to FIG. 19, after clicking the resume button, the resume application screen asks for the password previously created.

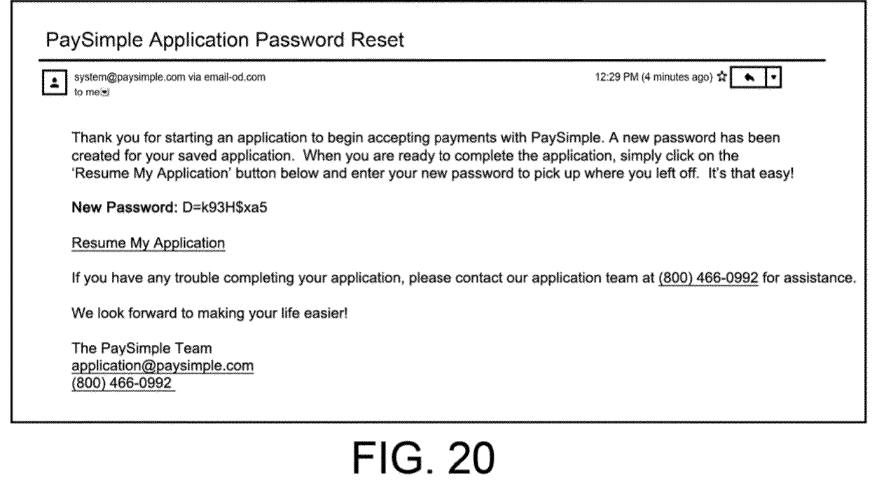

If the merchant cannot remember the password he or she set, they can click the “Forgot your password?” link to have a new password emailed to the address of record, as shown in FIG. 20. The merchant copies the password from the email and uses it on the resume application screen.

The SSU application opens where the merchant left off, with all previously entered data auto-filled. The applicant can now resume and complete the application, or add additional information and save again. Each time the “Save & Return Later” button is clicked, the merchant is prompted to enter a new password. The password can be the same as, or different from, the one used previously.

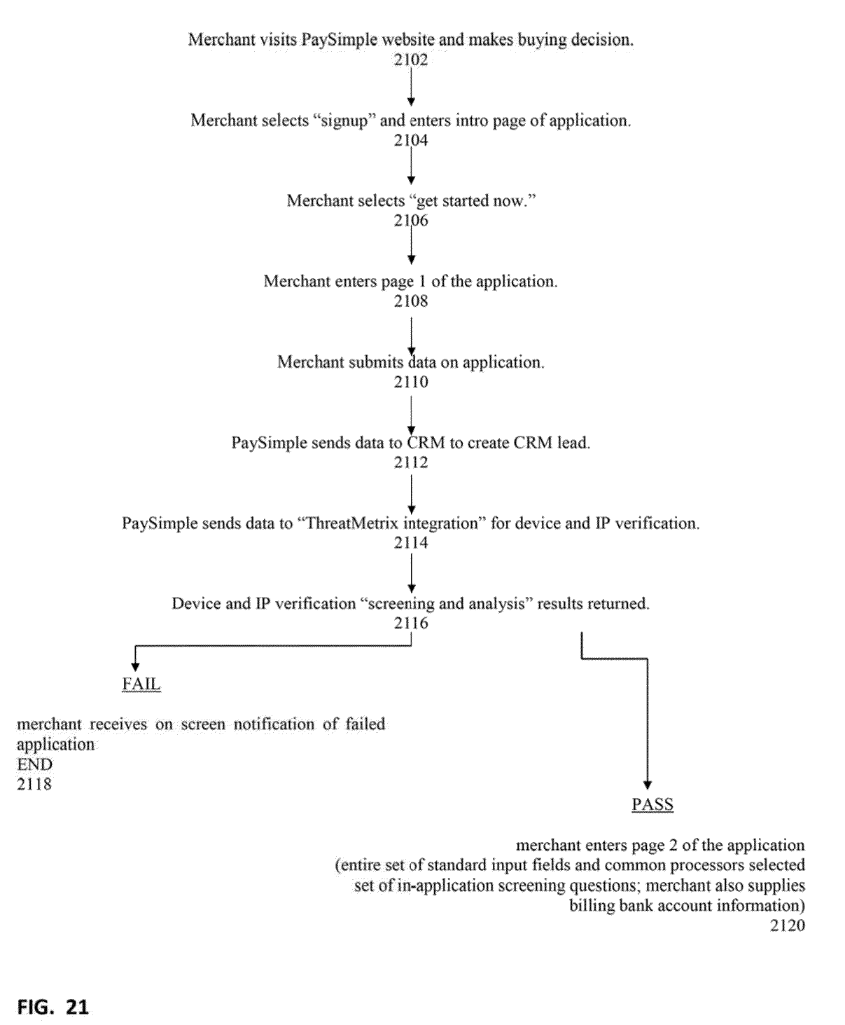

FIG. 21-FIG. 30 are flow diagrams illustrating a SSU process according to an embodiment for CC and ACH applications with multiple processors. Processors include entities for ACH processing and CC processing and comprise instances where a majority of the underwriting is done via the SSU process (in which case a larger number of questions and screens will be implemented) as well as instances where a substantial portion of underwriting is performed by the merchant account provider (in which case the SSU questions and screens will consist of only initial base-level screening). FIG. 21-FIG. 30 illustrates the merchant-facing UI aspect of the SSU and the provisioning infrastructure.

An embodiment of the CC and ACH SSU with multiple processors uses essentially the SSU application form as shown and described with reference to FIGS. 2-20. However, the embodiment includes additional filters and screens in the background to route merchants to one of multiple integrated credit card and ACH processors based on the merchant's responses to form questions.

For example, one processor might take only merchants with a credit score over 700, and another will accept those with scores as low as 600. As a further example, one processor might not want to underwrite merchants in the health club business, while another will accept such merchants.

In an embodiment, the system provider (e.g., PaySimple) establishes a stable of CC and ACH Processors that are integrated into the SSU process. This integration consists of: ISO relationships between PaySimple and Credit Card processors; revenue sharing or wholesale pricing relationships between PaySimple and ACH processors; revenue sharing or wholesale pricing relationships between PaySimple and Check 21 processors establishing pricing; providing PaySimple with terms and conditions documents that merchants will e-sign; integrating with PaySimple's SSU application via web services and/or SFTP; integrating with PaySimple CAMP for credentials transmission via web services and/or SFTP; integrating with the PaySimple® application for transaction authorization, batching, settlement, and reporting; establishing requirements for the data fields (in addition to SSU standard fields) that merchants are required to complete; establishing field filters to determine the merchants that processors will accept; establishing field filters that will disqualify a merchant and those that will send the merchant to manual; establishing security threat screening requirements and acceptable levels; and establishing the web service information processors require as a filter, and as an included data source.

The following are examples of the type of filter or screen that may be used. Any screen that can be run based on a data input field is in the scope of claimed embodiments:
Always route merchant to the lowest cost option
Business Type—not all processors underwrite all business types (i.e. LLC, Corp, sole proprietor, nonprofit)
Goods and Services—not all processors underwrite all types of product and service providers. For example, most will not underwrite tobacco merchants or pornography providers
Years in Business
Number of Employees
Average ticket size
Annual Processing Volume
High ticket size
Location (Country or State)
Authorized Signer (owner/officer) Credit Score
Security Threat Score
Bankruptcy Likelihood Score

A process flow according to an embodiment for an SSU implementation that uses merchant input to route to one of several ACH and/or Credit Card processors is described below. (The optional save/resume feature can be used with this embodiment.) This embodiment is described with reference to one example process. This example process includes using a form that enables application for a CC merchant account, an ACH merchant account, or both types of account using the same application. A similar process flow can be used for any type, number, and combination of merchant accounts. Examples of other embodiments include, an ACH only application, a CC only application, an application for ACH, CC and/or Check 21, etc.

Referring to FIG. 21, a customer (referred to also herein as a merchant or user) decides to open a PaySimple account (2102.) In embodiments described herein the system and method are provided by an entity that is referred to as PaySimple for purposes of illustration. The merchant clicks an online “signup” button and enters an introductory page of an online application (2104.) The merchant then enters the first page of an online application form by selecting “get started now” (2106.) Page one of the application asks for Name, Email and Phone Number. The merchant submits the information data using the online application (2110.) PaySimple sends the entered data to a customer relationship management (CRM) entity, such as SalesForce™, to create a lead (2112.)

The data is also sent to a web service for security threat screening. In an embodiment the data is sent to a service for risk evaluation (ThreatMetrix™ is used as an example) integration for device and IP verification (2114.) If the merchant is deemed too high risk to underwrite, the merchant receives an on-screen notification that they do not qualify to use the service, and the process ends (2118.) If the merchant passes the verification, the merchant may meet underwriting criteria for one or more processors. Any processor for which merchant does not meet underwriting criteria is eliminated from subsequent analysis.

The merchant then enters the second page of the application (2120), which asks for type of payment processing accounts for which the merchant wants to apply. It also asks for business information such as address, tax ID, type of business, goods/services sold, and information about the transaction size and volume the merchant will process. Additionally, it asks for the bank account that will be billed for services and attached to the merchant accounts. Information on this screen is created to encompass the first set of screening logic that routes a merchant to a particular processor.

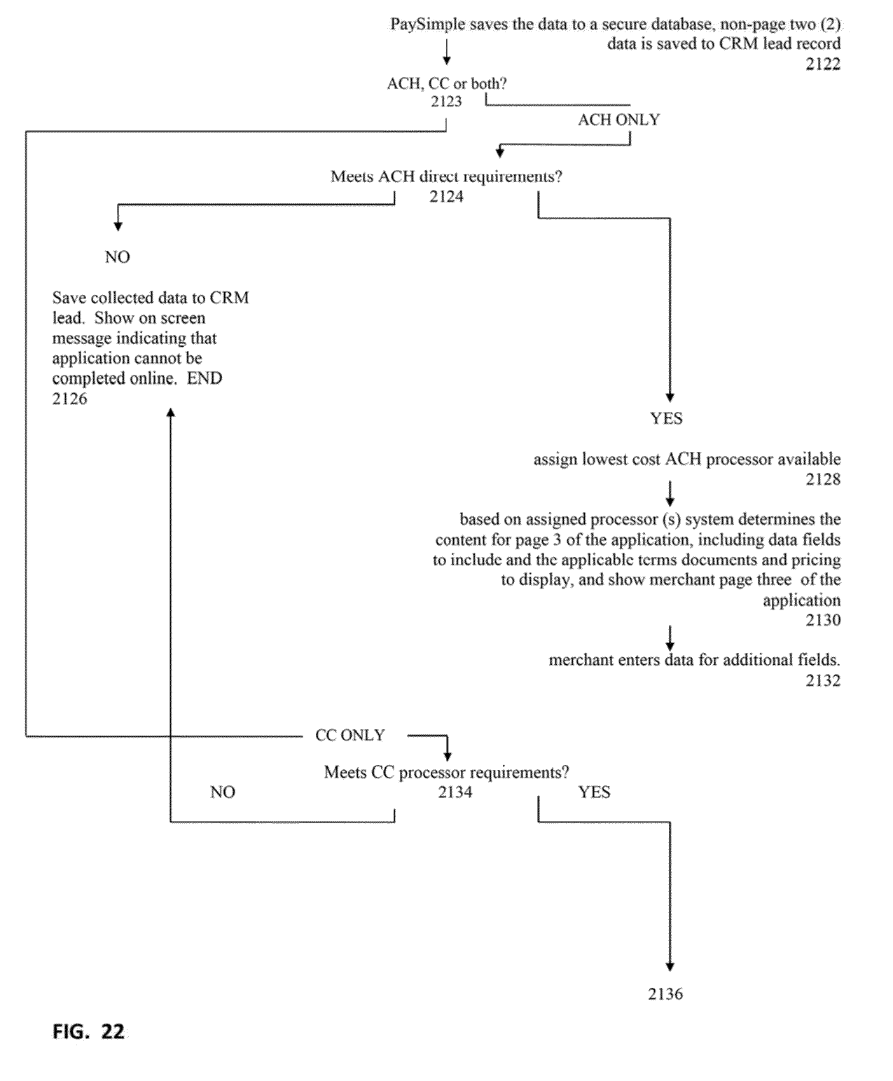

Referring next to FIG. 22, the type of merchant accounts applied for are used to determine which pool(s) to pull processors from. Type of merchant account, and data input requirements from applicable processors, are also used to dynamically create the remainder of the form. The merchant's bank account information is obtained. This account is used by the system for billing (by the system provider (e.g., PaySimple) to the merchant), and is also the account linked to CC and ACH merchant accounts. PaySimple saves the data to its secure database. In addition, data that was not collected on page two of the application is saved to the CRM lead (2122.)

SSU internal filters are then applied against the data collected in order to assign a processor.

The system first determines whether the merchant applied for an ACH account only, a CC account only, or both (2123.) If the merchant applied for an ACH account only, the system determines whether the merchant meets the requirements for all available ACH Processors (2124.) If the requirements are met, the system assigns the lowest cost ACH processor available (2128.) According to an embodiment, the lowest cost option is assigned if the requirements are met for one or more ACH processors. If the requirements for only one ACH processor are met, that processor is assigned. Based on the assigned processor(s), the system determines the content for page three of the application, including data fields to include and the applicable terms documents and pricing to display, and the system show the merchant page three of the application (2130.) The merchant then enters the data for additional data fields (2132.)

If the merchant does not meet the requirements for any ACH Processors, the collected data is saved to the CRM lead, a message is shown to indicate that the application cannot be completed online, and the process is at an end (2126.)

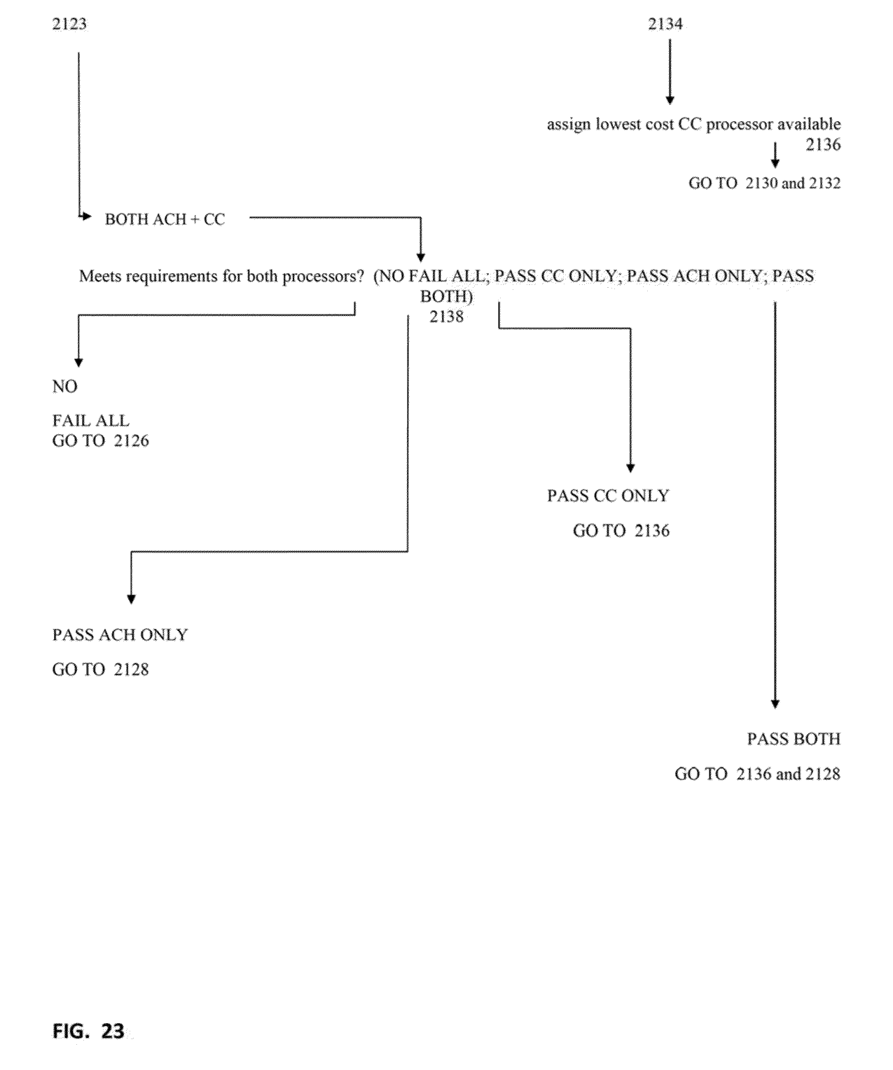

Referring now to FIG. 22 and FIG. 23, if the application was for a CC account only, the system determines whether the CC processor requirements for all available CC processors are met (2134.) If requirements for one or more CC processors are met the lowest cost option is assigned. If requirements for only one CC processor are met, that CC processor is assigned. (2136.) The process then goes to 2130 and 2132 (preparing and presenting page three information).

If the merchant does not meet requirements for any CC processors, the process goes to 2126 (save collected data, show message to applicant, and end.)

If the merchant applied for ACH and CC accounts, the system determines whether the merchant meets requirements for all available ACH and CC processors. If no requirements are met for either of CC processors or ACH processors, the process goes to 2126. If the merchant passes for CC accounts only, the process goes to 2136 (assign a CC processor, etc.)

If the merchant passes for ACH accounts only, the process goes to 2136 (assign an ACH processor, etc.) If the merchant passes for both ACH and CC, then the process returns to both 2136 and 2138. According to 2136 and 2138, the lowest cost option is assigned for each of CC and ACH processors if the merchant meets requirements for one or more ACH processors and one or more CC processors. If the requirements for only one ACH Processor and only one CC processor are met, those processors are assigned.

If the requirements for one or more ACH processors but no CC processors are met, the lowest cost ACH option is assigned, the remainder of the application is dynamically adjusted to eliminate application elements for a CC processing account. The system notifies the merchant on screen that the ACH application will continue, the CC application is not possible.

If the requirements for one or more CC processors but no ACH processors are met, the lowest cost CC option is assigned, and the remainder of application is dynamically adjusted to eliminate application elements for an ACH processing account. The merchant is notified on screen that the CC application will continue, the ACH application is not possible.

If the requirements are not met for any ACH processors or CC processors (FAIL ALL), the process goes 2126, where the collected data is saved to a CRM lead, etc.

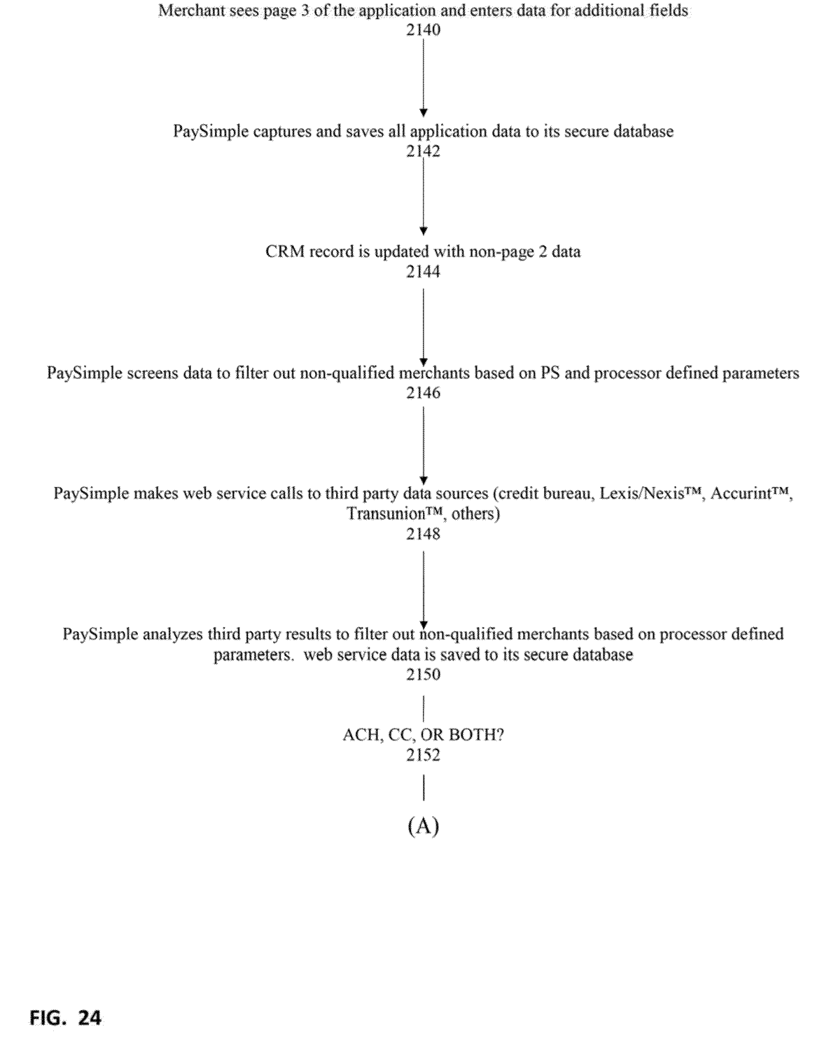

With reference to FIG. 24, the next SSU application page (this page is referred to arbitrarily as “page 3”, but the page could have any number) is dynamically generated to include additional data fields as required by the assigned processors. The merchant sees page three of the application and enters data for additional fields (2140.) Page three also asks for additional information about the business, for the authorized signer(s) to be designated, for personal information (SS#, position in the business, years in that position), and asks the authorized signer to view and agree to all terms, conditions, and fees as well as agreeing to be billed for system transaction activity and fees by PaySimple via a monthly ACH debit. The information on this screen is dynamically generated based on the type of accounts being applied for, and the terms and conditions documents applicable to each assigned processor. The authorized signer provides their contact information. The authorized signer is the person authorized to open the merchant account and to authorize automated billing. This person may be individually liable for all transaction activity and fees, or may be authorized to assign liability to the business (depending on processor requirements for a personal guarantee.) The screen provides an option to add an additional principal who will be a joint signer.

In an embodiment, promotional codes are used to provide discounts for monthly service fees, or special introductory discounts on processing rates. Including the code here enables a system-maintained client record to be configured to use these discounts. If the merchant currently accepts credit cards (and they are applying for a credit card processing account) they are asked additional questions about PCI compliance and any past security breaches. The bottom portion of the screen provides the merchant access to all contracts, terms, pricing, and conditions. By clicking the submit button the merchant is agreeing to all of the checkbox items. The information collected on this page is used to create a signature page that acts as an e-signature on all agreements. The submit button functions as an e-signature. The merchant clicks the submit button to e-sign and submit.

The merchant sees a processing screen while all the form information provided is sent to a securely hosted PaySimple database (2142.) The CRM (e.g., SalesForce™) record created earlier is converted to an account and an associated contact record, and non-secure information from the form submission is seated in the record. The SSU system screens the data to filter out non-qualified merchants based on PaySimple and processor-defined parameters (2146.)

The SSU system makes additional calls to third party service providers, and SSU internal security screens, as configured by a reseller, for further fraud detection and credit verification, such as: IP address velocity, email address velocity, ThreatMetrix™ (or similar service) score, bank account status, credit report, credit score, etc. (2148.) The system analyzes third party results to filter out non-qualified merchants based on processor-defined parameters, and the web service data is saved to a secure PaySimple database (2150.)

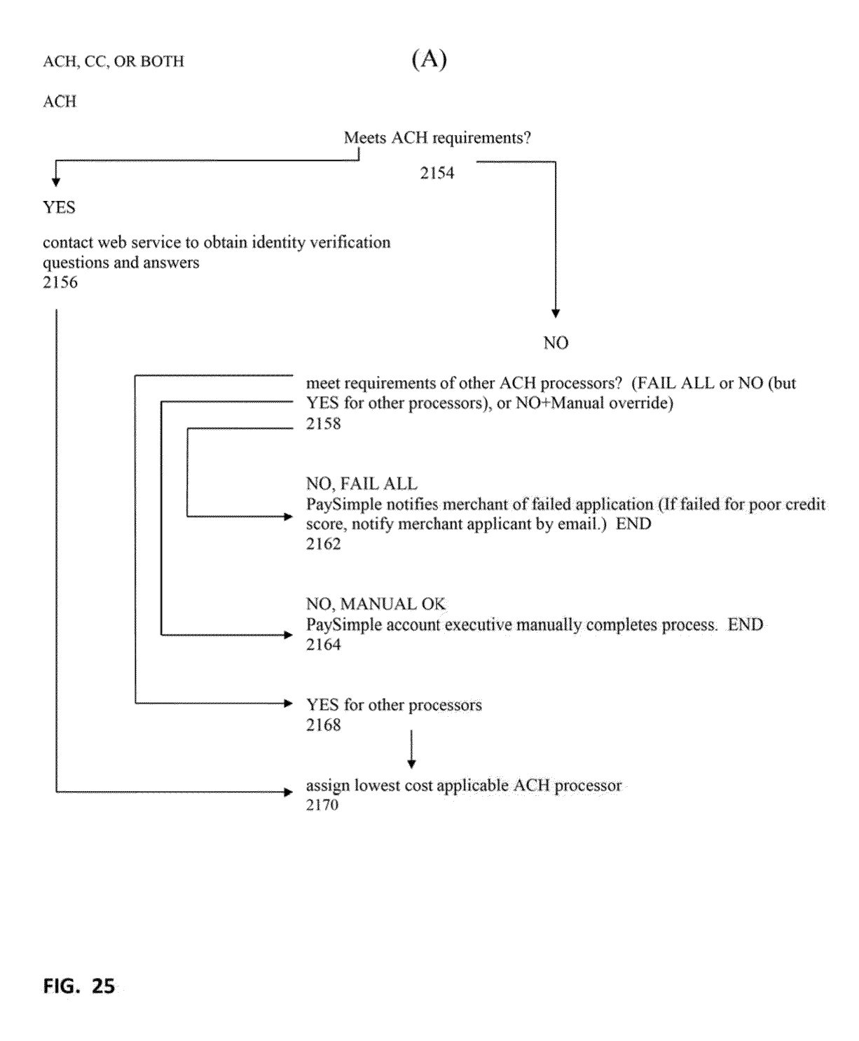

Processing of the application continues using the third party results and system criteria. The system again determines whether the merchant applied for a CC account, an ACH account, or both (2152.) Continuing to FIG. 25, If only an ACH account was applied for, the system determines whether the ACH requirements are met for the assigned ACH processor (2154.) If the requirements for the assigned processor are met, the system contacts web services to obtain identity verification questions and answers for the application (2232.) If the ACH requirements are not met for the current processor, the system determines (2158) whether the requirements are met for any other ACH processors.

If the situation is FAIL ALL, the system notifies the merchant of the failed application. If the failure was due to a poor credit score, the merchant is notified by email, and the process is at an end (2162.) If the situation is NO, MANUAL OK (2164), a PaySimple account executive manually completes the process with the applicant

If the situation is YES FOR OTHER PROCESSORS (2168), the system assigns the lowest cost available ACH processor (2170) and the process continues (2222).

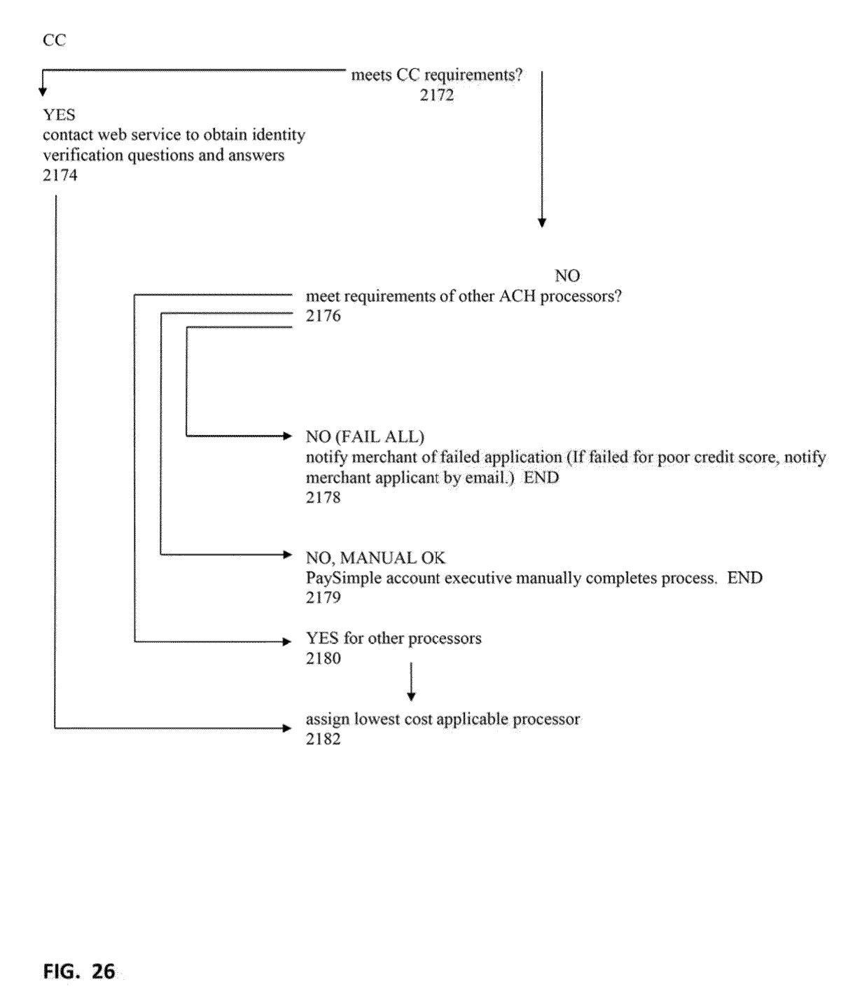

Referring to FIG. 26, the system determined that only a CC account was applied for. The system determines whether the CC requirements are met for the assigned CC processor (2172.) If the requirements for the assigned processor are met, the system contacts web services to obtain identity verification questions and answers for the application (2232.) If the CC requirements are not met for the assigned processor, the system determines (2176) whether the requirements are met for any other CC processors.

If the situation is FAIL ALL (2178), the system notifies the merchant of the failed application. If the failure was due to a poor credit score, the merchant is notified by email, and the process is at an end. If the situation is NO, MANUAL OK (2179), a PaySimple account executive manually completes the process with the applicant.

If the situation is YES FOR OTHER PROCESSORS (2180), the system assigns the lowest cost available CC processor (2182.) and the process continues (2222).

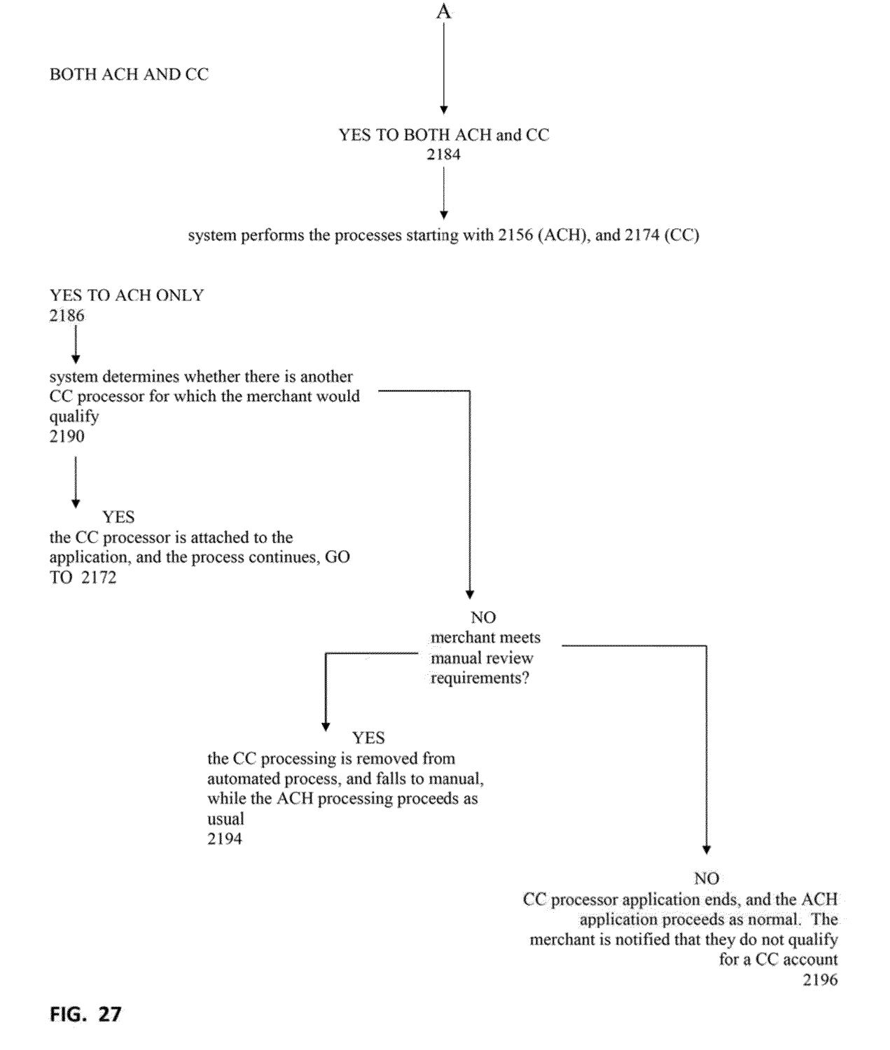

With reference to FIG. 27, if the merchant applies for both an ACH account and a CC account, the system determines whether the requirements for both assigned processors are met (2184), the requirements for the assigned ACH processor only are met (2186), the requirements for the assigned CC processor only are met (2188), or no assigned processor requirements are met (2206).

If both assigned ACH and CC processor requirements are met, the system performs the identity verification process (2230).

If requirements are met for the assigned ACH processor, but not the assigned CC processor (2186), the system determines whether there are other CC processors for which the merchant would qualify. (2190.)

If there are other CC processors for which the merchant would qualify, the lowest cost available CC processor is attached to the application and the process continues (2222). If there is no other CC processor for which the merchant would qualify, and merchant meets manual review requirements for CC, the CC processing is removed from automated process, and falls to manual, while the ACH processing proceeds as usual with the identity verification process (2230).

If the merchant fails all CC processor requirements outright, the CC processor application ends, and the ACH application proceeds as normal with the identity verification process (2230). The merchant is notified that they do not qualify for a CC account (2196.)

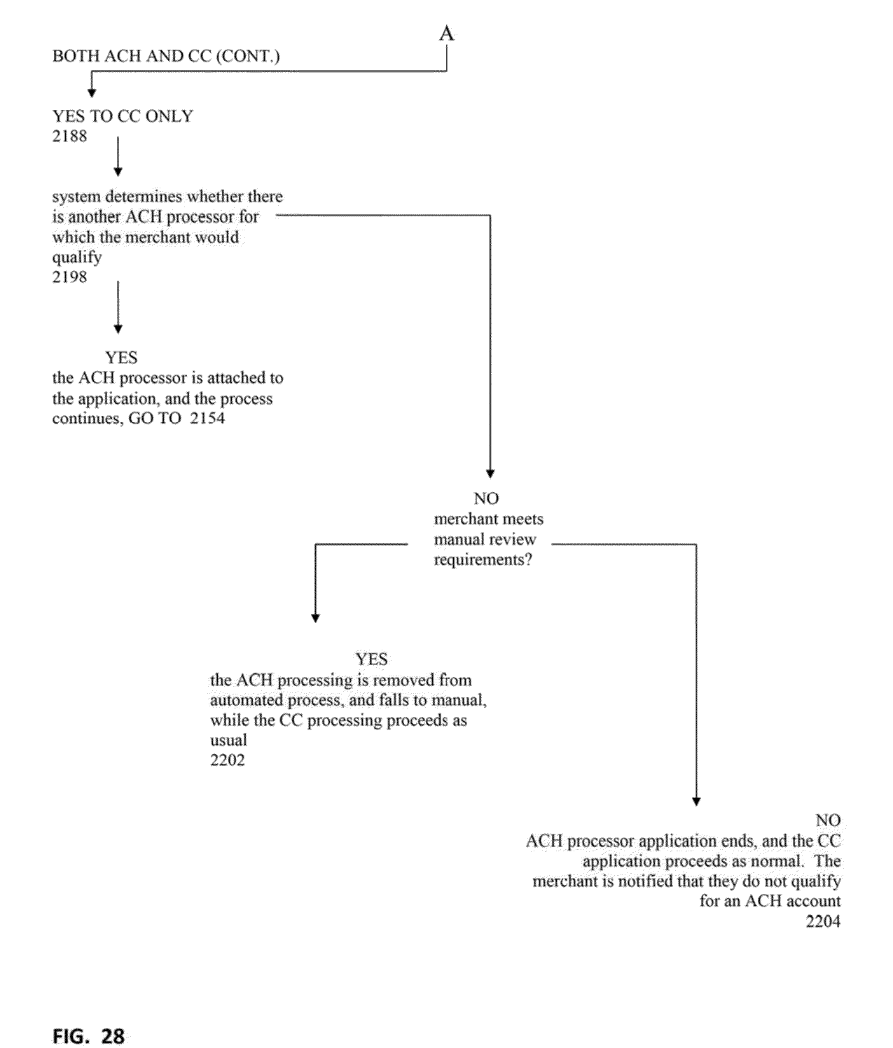

Referring to FIG. 28, if requirements are met for the assigned CC processor, but not the assigned ACH processor (2188), the system determines whether there are other ACH processors for which the merchant would qualify (2198.)

If there are other ACH processors for which the merchant would qualify, the system assigns the lowest cost available ACH processor and attaches it to the application and the process continues (2222).

If there is no other ACH processor for which the merchant would qualify, and the merchant meets manual review requirements, the ACH processing is removed from automated process, and falls to manual, while the CC processing proceeds as usual with the identity verification process (2232).

If the merchant fails all ACH processor requirements outright, the ACH processor application ends, and the CC application proceeds as normal with the identity verification process (2230). The merchant is notified that they do not qualify for an ACH account (2204.)

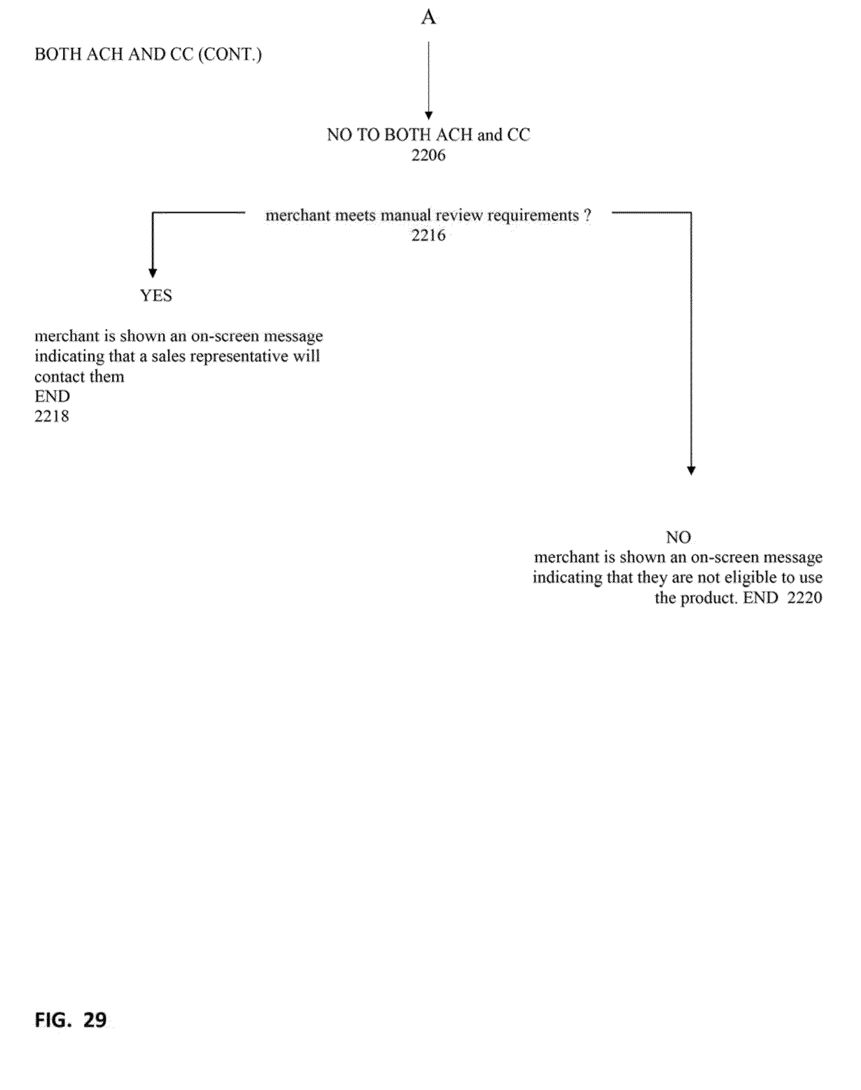

Referring to FIG. 29, if the there are no processors (CC or ACH) for which the merchant passes requirements (2206), it is determined whether the merchant meets manual review requirements (2216). If the merchant meets manual review requirements, the merchant is shown an on-screen message indicating that a sales representative will contact them, and the process ends (2218.) If the merchant fails outright, the merchant is shown an on-screen message indicating that they are not eligible to use the product, and the process ends (2220.)

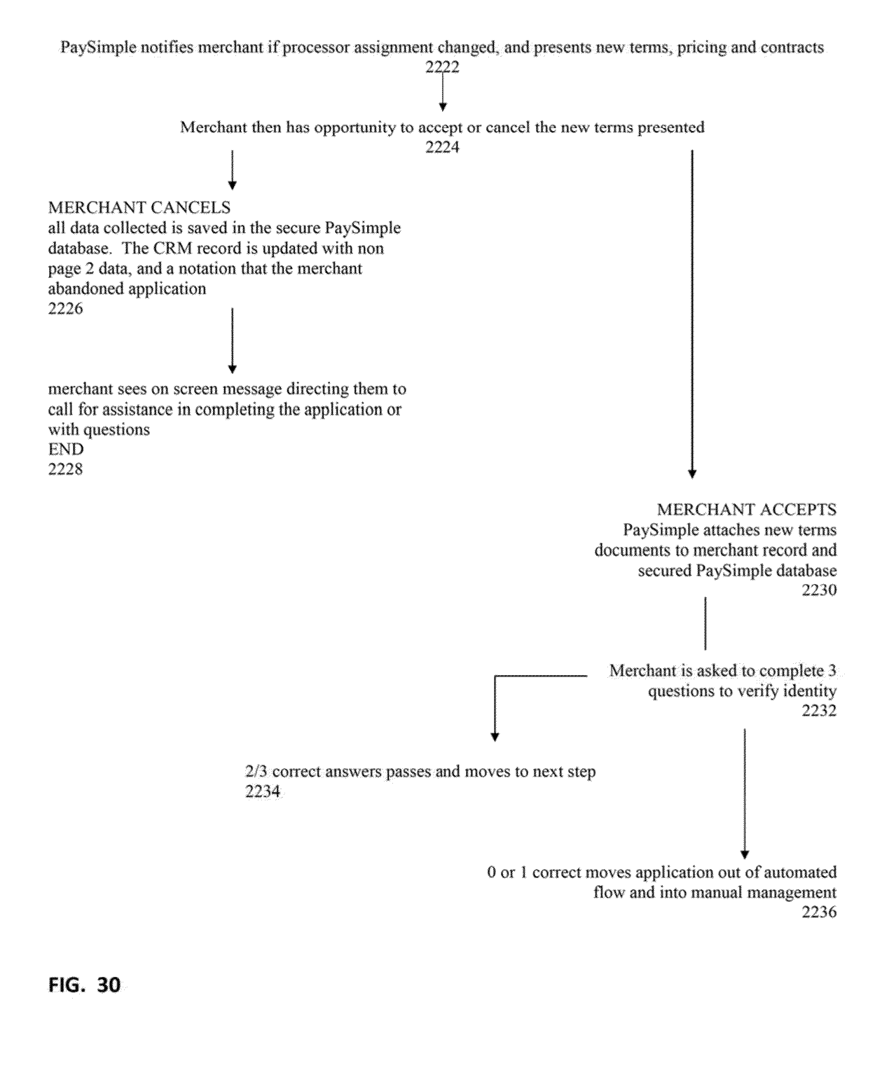

With reference to FIG. 30, if either ACH or CC processor assignment has changed due to previously described screening processes, the merchant is shown a screen with a message indicating that the initially assigned processor could not be used, and is given the option to review and agree to terms and conditions for the new processor (2222.) The merchant reviews, and checks boxes to agree and submits the form. (e-signature created with submit of the “agree” boxes) (2224.)

If the merchant clicks “Cancel” all data collected is saved in the secure PaySimple database. The CRM record is updated with all existing data, and a notation that the merchant abandoned application (2226.) The merchant sees an on screen message directing them to call for assistance in completing the application or with questions, and the process ends (2228.)

If the merchant accepts the new processor terms, or if all originally assigned processors remain attached to the application, he or she is asked to complete three questions to verify identity (2232). API calls to a third party service are used for this feature. Two out of three correct answers given by the merchant moves the process to the next step (2232). Zero or one correct answer moves the application out of automated flow and into manual management (2234). No further automated steps are taken. In an embodiment, the merchant is told their application is submitted, but actual application and boarding is manually handled.

A CAMP record for the customer is created from the form data, and is given a “Pending” status. The merchant sees a success screen confirming that the application(s) have been submitted and that they will receive system credentials as soon as their applications have been approved.

An automated underwriting, approval, and the boarding process then begins. Form information is used to create a signature page attached to the CAMP record. A SSU application Results page is available from the CRM record, but in an embodiment is stored in the secure PaySimple database. This page indicates the results from all the native and web service screens and database calls. Form information, SSU application results, and web service data are electronically submitted to the applicable credit card processor via a web service integration. Form information, signature page, and SSU application results are electronically submitted to the ACH processor via a web service integration.

The Credit Card processors transmits application results via web service or SFTP. For an “approved” result from a CC processor, the CAMP account is switched from “pending” to “active”, and the customer is sent login credentials. The CRM record is updated to indicate that the customer is boarded. If the result from the CC processor is “additional information required”, a PaySimple account specialist takes over the process and manually completes it. The CRM record is updated to indicate manual intervention was needed. If the result from the CC processor is “denied” and only a CC merchant account was requested, the CRM account is updated to indicate that result. The PaySimple sales team communicates with the merchant to try to establish an ACH or Invoicing Only account. If the result from the CC processor is “denied” and only an ACH merchant account was applied for, the CRM record is updated to indicate that CC processing is denied, and account remains pending until ACH application response is received.

ACH processors transmit application results to the system via a web service or SFTP. If the result is “approved”, ACH processing is turned on and configured in CAMP. The customer receives email notification. If the result is “Additional Information Required” a PaySimple account specialist takes over process and manually completes it. The CRM record is updated to indicate manual intervention was needed. If the result is “Denied” and only ACH merchant account was requested, the CRM account is updated to indicate denied. The sales team communicates with the merchant to try to establish an Invoicing Only account. If ACH was denied and a CC merchant account approved, the CRM account is updated to indicate that ACH processing is denied, and the account remains open with CC processing only.

In an embodiment as described herein, SalesForce™ is used for CRM, and all SSU applicants, whether they complete the application or not, are stored as leads in the CRM. The SalesForce™ API is used to integrate SSU, and PaySimple's proprietary CAMP customer acquisition and management platform, with the CRM. However, use of any other proprietary or third party CRM integration instead of SalesForce™ is also within the scope of the invention as disclosed.

CAMP is an embodiment of a customer boarding and management platform for all customers (merchants) using any version of the PaySimple software application. It is the end-point for all SSU applications. Once an applicant makes it through the initial screens (at the point where information is passed to a processor for additional underwriting) a provisional CAMP account is created for the client. Documents related to the client are cataloged and accessible from CAMP. Payment processing credentials are uploaded into CAMP and associated with a client record, as part of the process for enabling a client (merchant) to process transactions via the PaySimple software.

The SSU customization process for white-label resellers is performed from within CAMP as part of a reseller management component. This customization can include selecting screening questions and acceptable parameters, attaching their own sponsored payment processing merchant accounts to the SSU application (in place of standard PaySimple integrated third party processors), and creating custom branding for the SSU UI.

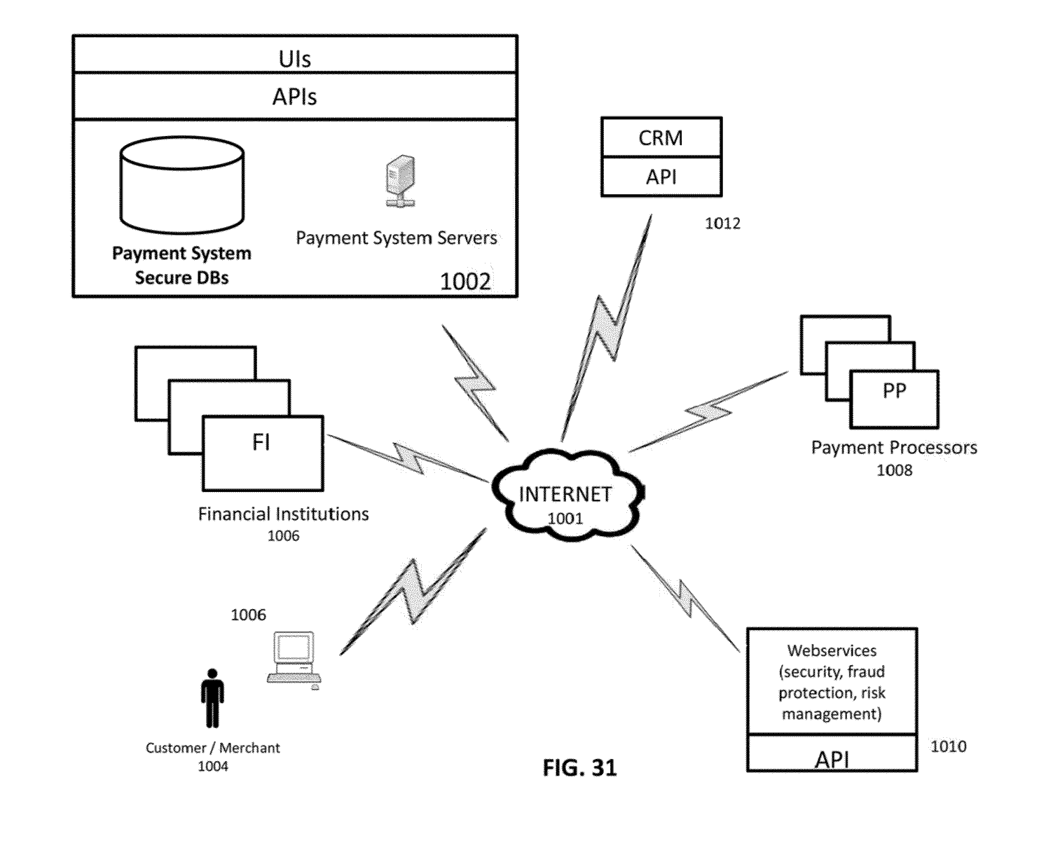

FIG. 31 is a block diagram of a system 1000 according to an embodiment. System 1000 includes a payment system 1002 including secure databases, data servers, APIs and UIs. As previously described in this document, PaySimple is an example of a payment system embodiment, but the invention is not so limited. Customers such as customer/merchant 1004 can sign up for the software-as-a-service (SAAS) products as described herein by communicating with payment system 1002 using a computer 1006 and the payment system 1002 UIs. In various embodiments, customer/merchant 1004 can communicate with the payment system 1002 using any device capable of communicating over Internet 1001 and executing any instruction involved in the processes described herein. These devices include machines with computer processors in any configuration including mobile phones, tablets, etc.

Payment system 1002 is also configured to communicate with one or more CRM providers 1012. An example of a CRM provider is SalesForce™, but there are others. Payment system 1002 is also configured to communicate with various web services 1010. Web services 1010 include services that perform security, fraud prevention and risk management functions, among others. For example, but without limitation, web services can include Idology™, TransUnion™, IP2Location™, LexisNexis™, etc. As appropriate, either payment system 1002 and/or other system 1000 entities such as web service 1010 and CRM 1012 provide APIs for use of other entities. Multiple payment processors 1008 are also connected to Internet 1001 and communicate (as described herein) as necessary with one or more of the entities shown. Payment processors include entities that facilitate ACH and CC payments and underwrite ACH and CC accounts on behalf of Financial Institutions 1006. Financial institutions 1006 include any institutions that provide the actual transaction settlement functions for payments processed. In addition, processing pipes 1014 participate in transactions via the Internet 1001. Processing pipes 1014 provide authorization and capture of CC transactions. For example, a transaction by a PaySimple merchant originates in the PaySimple system. The transaction then goes out through an authorization and capture pipe (e.g., Tsys®) which transmits back an authorization code or a failure code. Part of the information sent to the processing pipe is the Merchant ID assigned to the merchant by the Payment Processor 1008. In the background the processing pipe determines that the merchant has been underwritten by the Payment Processor (e.g. North American Bancard) 1008 to process CC transactions, and verifies that the presented Merchant ID is valid. Once the merchant is verified, the processing pipe transmits an authorization response. That authorization response is batched by the PaySimple system and sent back over the same pipe. The processing pipe then sends the information through the Card Brands (e.g. Visa) processing system, from which it is sent to the underwriting FI 1006. The FI then funds the merchant's account.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e g, optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of components and/or processes under the system described may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

While certain aspects of the systems and methods are presented below in certain claim forms, the inventors contemplate the various aspects of the systems and methods in any number of claim forms. For example, while only one aspect of the systems and methods may be recited as embodied in machine-readable medium, other aspects may likewise be embodied in machine-readable medium. Accordingly, the inventors reserve the right to add additional claims after filing the application to pursue such additional claim forms for other aspects of the systems and methods.

1-13. (canceled)

14. A computer-implemented method for generating an application for a merchant account, the method comprising:
presenting by a system server a merchant customer user interface to a merchant customer user, wherein the system server is part of an Internet payment processing, merchant account application and underwriting system configurable to communicate with a plurality of merchant account acquirers via the Internet;
receiving by the system server user data from the merchant customer user interface, wherein the user data includes information requested via the merchant customer user interface for an application for a payment processing merchant account;
processing the user data by the system server, wherein processing the user data comprises pre-screening the user data in order to assign an initial merchant account acquirer;
collecting by the system server additional information, comprising performing calls to one or more third party Internet services for fraud detection, credit verification, and other underwriting data;
further analyzing the user data by the system server to determine if the application for a payment processing merchant account continues to meet requirements of the initial merchant account acquirer's screening requirements;
when the initial merchant account acquirer's screening requirements are met, transmitting by the system server via the Internet the application for a payment processing merchant account to the initial merchant account acquirer;
generating by the system server an application for a payment processing merchant account using the user data and the additional information, wherein the application for a payment processing merchant account is appropriate to a plurality of types of merchant account acquirers, wherein the plurality of types comprise credit card (CC) processors, automated clearing house (ACH) processors, and electronic check processors utilizing a system by which a substitute check based on a paper check source document or other permissible authorization source is submitted for processing, in compliance with relevant laws;
receiving by the system server via the Internet a decision from the initial account acquirer approving or denying the application for a payment processing merchant account.

15. The method of claim 14, further comprising:
when the initial account acquirer's requirements are not met, determining by the system server whether there is an alternate CC processor account acquirer to which the application for a payment processing merchant account can be sent;
when there is an alternate CC processor account acquirer, presenting an option by the system server to the user to review terms and electronically sign applications and contracts;
transmitting via the Internet the application for a payment processing merchant account by the system server to the alternate CC processor account acquirer; and
receiving via the Internet by the system server a decision approving or denying the application for the payment processing account.

16. The method of claim 14, further comprising:
determining by the system server that the initial merchant account acquirer denied a CC application based on screening parameters, but screening parameters of another merchant account acquirer allowed an ACH application;
determining by the system server whether there is an alternate CC processor merchant account acquirer to which the denied application can be sent;
when there is an alternate CC processor merchant account acquirer, presenting by the system server to the user an option to review terms and electronically sign applications; and
the system transmitting via the Internet by the system server the denied application to the alternate CC processor merchant account acquirer.

17. The method of claim 14, further comprising:
determining by the system server that the initial merchant account acquirer denied an ACH application based on screening parameters, but screening parameters of another merchant account acquirer allowed a CC application;
determining by the system server whether there is an alternate ACH processor merchant account acquirer to which the denied application can be sent;
when there is an alternate ACH processor merchant account acquirer, presenting by the system server to the user an option to review terms and electronically sign applications; and
transmitting the denied application by the system server to the alternate ACH processor merchant account acquirer.

18. The method of claim 14, further comprising:
initiating by the system server an automatic process for underwriting and boarding for each approved application, wherein the automatic process comprises,
transmitting by the system server received information and screening result information to one or more merchant account acquirers;
receiving by the system server underwriting results and merchant account credentials from the one or more merchant account acquirers; and
activating by the system server an account for the user on the Internet payment processing, merchant account application and underwriting system.

19. The method of claim 14, wherein the merchant customer user interface further comprises a configuration tool, wherein the method further comprises receiving by the system server reseller user input through the configuration tool from a reseller user to customize information requests and screening parameters included in the merchant customer user interface presenting applications for payment processing merchant accounts.

20. The method of claim 19, further comprising receiving by the system server reseller user input through the configuration tool from the reseller user to select Internet services to be used in conjunction with applications for payment processing merchant accounts presented via the merchant customer user interface.

21. The method of claim 19, further comprising receiving by the system server reseller user input through the configuration tool from the reseller user to set screening parameters to be used for prescreening merchant customer user data collected via the merchant customer user interface.

22. The method of claim 19, further comprising receiving by the system server, reseller user input through the configuration tool from the reseller user to set its the reseller user's own credit card merchant account offering as the only credit card merchant account offering available to the merchant customer user through the merchant customer user interface.

23. The method of claim 19, further comprising receiving by the system server reseller user input through the configuration tool from the reseller user to set the reseller user's own ACH merchant account offering as the only ACH merchant account offering available to the user through merchant customer user interface.

24. The method of claim 19, further comprising receiving by the system server reseller user input through the configuration tool from the reseller user to set the reseller user's own credit card merchant account offering, and the reseller user's own ACH merchant account offering, as the only ones available to the user through the merchant customer user interface.

25. The method of claim 23, further comprising receiving by the system server reseller user input through the configuration tool from the reseller user to include the reseller user's own paper check and substitute check handling merchant account offering.

26. The method of claim 24, further comprising receiving by the system server reseller user input through the configuration tool from the reseller user to include its own paper check and substitute check handling merchant account offering.

27-30. (canceled)
